(19) United States
(12) Patent Application Publication
(10) Pub. No.: US 2012/0179538 A1
(43) Pub. Date: Jul. 12, 2012

(54) System and Method for Creating and Managing Campaigns of Electronic Promotional Content, Including Networked Distribution and Redemption of Such Content

(76) Inventors: Scott Hines, Fountain Hills, AZ (US); Michael Chadwick, Chandler, AZ (US); Paul Bentley, Escondido, CA (US)

(21) Appl. No.: 13/346,542

(22) Filed: Jan. 9, 2012

Related U.S. Application Data
(63) Continuation-in-part of application No. 13/198,617, filed on Aug. 4, 2011.
Application No. 13/198,617 is a continuation-in-part of application No. 13/100,625, filed on May 4, 2011.
(60) Provisional application No. 61/485,527, filed on May 12, 2011.
(60) Provisional application No. 61/431,145, filed on Jan. 10, 2011.

(51) Int. Cl. G06Q 30/02

(52) U.S. Cl. 705/14.43; 705/14.51; 705/14.41

(57) ABSTRACT

A system and method for creation and management of Promotional Campaigns which specify items of EPC that are distributed to Mobile Users. The systems and methods involving networked distribution and redemption of such content.

### CROSS-REFERENCE TO RELATED APPLICATIONS

The present invention is a continuation-in-part of U.S. patent application Ser. No. 13/198,617 entitled “System and Method of Digital Display Integration for Electronic Content Exchange,” which is a continuation-in-part of U.S. patent application Ser. No. 13/100,625 entitled “System and Method of Electronic Offer Promotion Redemption” filed May 4, 2011 and claims priority to U.S. Provisional Patent Appl. Ser. Nos. 61/485,527 and 61/431,145. The subject matter disclosed in patent application Ser. Nos. 13/198,617 and 13/100,625 as well as U.S. Provisional Patent Appl. Ser. Nos. 61/485,527 and 61/431,145 is hereby incorporated by reference into the present disclosure as if fully set forth herein.

### BACKGROUND OF THE INVENTION

1. Field of the Invention

The present invention relates generally to wireless exchange of electronic content, and more particularly to a system and method of electronic content exchange.

2. State of the Art

Coupon clipping is a multi-million dollar activity that occurs in households across America. Shoppers take advantage of price savings offered through advertisement by manufacturers for specific products by cutting out these coupons and redeeming them at local grocery and retail stores. Traditionally, the process of clipping and organizing coupons has taken a significant amount of time and effort even to the extent that systems for managing coupons manually have been developed. The digital age has also recognized the inefficiency of clipping and organizing coupons and has improved the process by making coupons available online for easy sorting and printing prior to redeeming them at a grocery or retail store. However, even with the use of a computer to sort and print coupons, significant time and effort are still required by the consumer. Furthermore, there are digital signs that display coupons or offers to consumers; however, a user is still required to access the digital sign online via a computer.

Other limitations of using printed offers or coupons include discovering all coupons that are actually available as well as tracking expiration dates of coupons. Consumers often discover at the point of purchase that a coupon exists for a product they are in the process of purchasing, or discover that coupons they are attempting to use are already expired. This can cause undesirable consumer frustration.

### SUMMARY OF THE INVENTION

This summary is provided to introduce a selection of concepts in simplified form that are further described below in the Detail Description. This summary is not intended to identify key features of the claimed subject matter, nor is it intended to be used as an aid in determining the scope of the claimed subject matter.

As used herein, the term “Electronic Promotional Content” OR “EPC” means digital content that carries information for promoting or otherwise conveying information about products or services of a commercial entity or a government entity or other entity. Electronic Promotional Content can include electronic coupons (sometimes referred to as mobile coupons), electronic rebates, electronic codes, or other digital items that can be redeemed for a financial discount (or other benefit) when purchasing a product or service. Customarily, electronic coupons are issued by manufacturers of consumer packaged goods (or by retailers) to be used in retail stores as a part of sales promotions. The EPC can include multimedia content, such as video, images, animations, and audio. The EPC can be referred to by URLs, filenames or other suitable references. Meta-data can be associated with the references to provide context for the EPC.

As used herein, the term “Ad” means digital content that carries information that is communicated to an audience (viewers and/or listeners) for the purpose of encouraging or persuading the audience to continue or take some new action. Most commonly, the desired result is to drive consumer behavior with respect to a commercial product or service, although political and ideological advertising is also common. Commercial advertisers often seek to generate increased consumption of their products or services through “branding,” which involves the repetition of an image or product name in an effort to associate certain qualities with the brand in the minds of consumers. Non-commercial advertisers who spend money to advertise items other than a consumer product or service include political parties, interest groups, religious organizations and governmental agencies. Ads can include multimedia content, such as video, images, animations, and audio. Ads can take the form of banner ads, pop-up ads, floating ads, interstitial ads, unicast ads, takeover ads and contextual ads, all of which can be displayed on Digital Signs (particularly In-store Digital Signs) or other display systems. Electronic Promotional Content can be related to one or more Ads. For example, a coupon for $2 off any one package of Huggies® Little Movers Slip-on Diapers can be related to one or more advertisements for such diapers.

As used herein, the term “Content Management System” or “CMS” is a system that communicates with a number of Networked Digital Signs to manage and control the media content displayed on the Networked Digital Signs. The CMS allows for automated management of such media content, including content collection from one or more sources, scheduling content delivery and playback time, and delivery (delivery of media content to the Networked Digital Signs). The media content managed by the CMS can be Ads as well as other media (such as menus, messages and other information).

As used herein, the term “Networked Digital Sign” or “Digital Sign” is an electronic display system that displays media content (such as video, images, etc.) under control of a CMS. The Networked Digital Sign interfaces to the CMS utilizing network communication (typically via messaging over a LAN/WAN(Internet)) to receive and store media content communicated from the CMS. The Networked Digital Sign can play/display the stored media content according to a predetermined schedule dictated by the CMS. The Networked Digital Sign can employ commercially available display products (such as LCD, LED, plasma display products) and can be found in public and private environments, such as retail stores, hotels, restaurants and corporate buildings. It is also contemplated that the Networked Digital Sign can be realized by any networked display device, such as interactive television systems for the home, office and car, networked computers, mobile computing devices, and networked automobile AV systems.

As used herein, a “Point-of-sale (POS) Terminal” is a system for carrying out a sales transaction between a customer (buyer) and a merchant (seller) for the sale of goods or services. The retailing industry is one of the predominant users of POS Terminals. In this industry, the POS Terminal typically includes a computer, a display monitor, a cash drawer, receipt printer, customer display, a barcode scanner, and a debit/credit card reader. It can also include a weight scale, a signature capture device for credit card processing, and a customer pin pad device for debit card processing. The POS terminal can utilize touch-screen technology for ease of use. The POS Terminal is used in conjunction with a checkout process where the goods or services that are to be purchased by the customer (buyer) are entered into the POS Terminal (for example by bar code scanning or by touch screen input) and totaled. Coupons or other promotional items (such as customer loyalty programs) can be applied to the totaled price to reduce the totaled price. The POS Terminal also allows for payment of the net totaled price (for example, by cash payment, a credit card transaction, a debit card transaction, or other suitable banking transaction). The POS Terminal can also handle a myriad of other customer based functions such as returns, exchanges, layaways, gift cards, gift registries, etc. In the restaurant industry, the POS Terminal is typically realized by a touch screen terminal or wireless handheld device. The POS Terminal functions to enter and print orders to kitchens and bars for preparation, and print guest checks for presentment to customers. Coupons or other promotional items can be applied to the total price for the guest check to reduce the total price. The POS Terminal also allows for payment of the net total price (for example, by cash payment, a credit card transaction, a debit card transaction, or other suitable banking transaction).

As used herein, the term “Networked POS Terminal” is a POS Terminal adapted to interface to the Cloud Service of the present application using network communications.

As used herein, the term “User” means an operator or application that accesses the Cloud Service of the present application under a certain type.

As used herein, the term “Mobile User” is a User who owns and/or controls a mobile unit that is configured with software functionality (referred to herein as the “Cloud Service Application) for accessing the Cloud Service of the present application.

As used herein, the term “Promoting Entity User” is a User who operates a Promoting Entity system in order to interact with the Cloud Service of the present application to create and/or manage Promotional Campaigns, which are intended to distribute EPC to Mobile Users. There can be one or more Promoting Entity Users that can access and/or manage a given Promotional Campaign (or a given group of Promotional Campaigns). Promotional Entity Users can be one or more authorized users of ad agencies, brand management entities, publishers or other operators wishing to deploy EPC to Mobile Users.

As used herein, the term “Promotional Campaign” means a collection of information relating to the needs of a Promoting Entity, the information including items of EPC and possibly other information such as start and end dates, targeting criteria that relates EPC to designated Ads (and/or to a designated group of Mobile Users), and metrics (e.g., goals for number of EPC items transferred to Mobile Users and/or viewed by Mobile Users and/or redeemed by Mobile Users (per campaign, program and/or date), costs, redemption rates, percentage of redeemers that are incremental customers, etc.) for the Promotional Campaign.

In accordance with one aspect of the present application, a system is presented. The system includes a Cloud Service that interfaces to a Promoting Entity system utilizing networked communication to provide for interaction with a Promoting Entity User of the Promoting Entity system. Such interaction allows for creation and management of Promotional Campaigns which specify items of Electronic Promotional Content (EPC) that are distributed to Mobile Users. The Promoting Entity system is operated by the Promoting Entity User and can be realized by a networked computer (such as a personal computer, laptop, netbook, tablet, workstation, server, PDA, smartphone or other computing device) with a web browser or other suitable software for interacting with the Cloud Service utilizing networked communication.

The items of EPC of the Promotional Campaigns managed by the Cloud Service are related to media content (such as Ads) displayed by one or more Networked Digital Signs under control of a CMS Service. The Networked Digital Signs interface to the CMS Service utilizing network communication to receive and store media content communicated from the CMS Service. The CMS Service includes a content database that stores media content (including Ads) that is supplied to the Networked Digital Signs. The Networked Digital Signs can play/display the supplied media content (e.g., Ads) according to a predetermined schedule dictated by the CMS Service.

The system also includes mobile units. Each respective mobile unit is loaded with an application (referred to as the “Cloud Service Application”) that executes on the respective mobile unit. The Cloud Service Application can be an installed application or possibly software (such as an ActiveX control, or Silverlight control, or Java applet, or html/javascript interface or the like) that is accessible form a web site or wap site. The Cloud Service Application interfaces to the Cloud Service utilizing networked communication to provide for distribution of items of EPC to the mobile units for access by Mobile Users.

The Cloud Service stores electronic information (referred to herein as a “virtual wallet”) for each Mobile User. The virtual wallet for a respective Mobile User represents items of EPC that are associated with the respective Mobile User. The items of EPC can be requested by the respective Mobile User or otherwise transferred to the respective Mobile User (for example, automatically transferred by the Cloud Service in conjunction with a Promotional Campaign managed by the Cloud Service). The Cloud Service Application executing on a respective mobile unit can cooperate with the Cloud Service using networked communication to allow the Mobile User to query the Cloud Service for items of EPC that are stored as part of the virtual wallet of the Mobile User and to display or otherwise access one or more items of EPC of the virtual wallet of the Mobile User.

The Cloud Service Application executing on a respective mobile unit can also cooperate with the Cloud Service using network communication to allow for automatic distribution of items of EPC to the virtual wallet of a respective Mobile User in response to interaction between the respective Mobile User and a Networked Digital Sign. The interaction between the Mobile User and the Networked Digital Sign conveys an intent to interact by the Mobile User. It is contemplated that the Mobile User will convey an intent to interact while viewing a particular Ad displayed on the Networked Digital Sign, and the automatic distribution of EPC to the virtual wallet of the Mobile User adds to the virtual wallet zero or more items of EPC that are of interest to the Mobile User and related in some manner to the particular Ad. The added item(s) of EPC are thus accessible as part of the virtual wallet of the Mobile User through network communications with the Cloud Service.

In one embodiment, the interaction between the Mobile User and the Networked Digital Sign involves the Mobile User holding the mobile unit in his/her hand and performing a hand-based gesture (such as a wave or shake or flick) with the mobile unit held in that hand. The Networked Digital Sign includes a sensing system (e.g., one or more image-based sensors and suitable imaging processing software) that automatically detects likely occurrence of the hand-based gesture. In response to the detection of the likely occurrence of the hand-based gesture by the Networked Digital Sign, the Networked Digital Sign issues a Meet-Me Request message to the Cloud Service utilizing networked communication. The Cloud Service Application executing on the mobile unit also includes a sensing system (e.g., accelerometer monitoring and processing software) that automatically detects the likely occurrence of the hand-based gesture. In response to the detection of the likely occurrence of the hand-based gesture by the Cloud Service Application executing on the mobile unit, the Cloud Service Application executing on the mobile unit issues a Meet-Me Request message to the Cloud Service utilizing networked communication.

The Meet-Me Request message pair that corresponds to a given interaction between a Mobile User and a Networked Digital Sign are communicated to the Cloud Service in an asynchronous manner. Moreover, in large scale deployments, there can be a number of Meet-Me Request message pairs corresponding to different interactions that are received at the Cloud Service at or near the same time. In order to address these issues, the Cloud Service includes logic that matches the received Meet-Me Request messages with spatial and temporal correlation processing in order to identify a logical connection or linkage (i.e., a one-to-one correspondence) between the Networked Digital Sign and the respective mobile unit (particularly, a logical connection between the Networked Digital Sign the Cloud Service Application executing on the respective mobile unit). The correlation processing can also correlate parameters of the hand gestures sensed by the Networked Digital Signs and Mobile Units in order to identify the a logical connection or linkage (i.e., a one-to-one correspondence) between the Networked Digital Sign and the respective mobile unit (particularly, a logical connection between the Networked Digital Sign the Cloud Service Application executing on the respective mobile unit).

In other embodiments, other contactless forms for interaction can be used to identify a logical connection or linkage (i.e., a one-to-one correspondence) between the Networked Digital Sign and the respective mobile unit (particularly, a logical connection between the Networked Digital Sign the Cloud Service Application executing on the respective mobile unit).

In accordance with another aspect of the present application, in response to the identification of a logical connection or linkage (i.e., a one-to-one correspondence) between a Networked Digital Sign and a respective mobile unit by the Cloud Service, the Cloud Service dynamically identifies zero or more items of EPC that are related to the particular information displayed/played on the Networked Digital Sign at or near the time of issuance of the Meet-Me Request message from the Networked Digital Sign to the Cloud Service, and then adds such item(s) of EPC to the virtual wallet of the Mobile User of the linked mobile unit for user access via the Cloud Service Application executing on the respective mobile unit. In one embodiment, the Meet-Me Request message issued by the Networked Digital Sign includes data (such as an identifier or other meta-data) related to the particular Ad displayed on the Networked Digital Sign at or near the time of issuance of the Meet-Me Request message from the Networked Digital Sign to the Cloud Service. The Cloud Service uses such data to dynamically identify zero or more items of EPC that are related to the particular Ad for addition of such item(s) of EPC to the virtual wallet of the Mobile User. The Cloud Service can also dynamically identify EPC items that are not directly related to the products or service of the particular Ad, but instead are complimentary or related in some other manner to the products or services of the particular Ad. In this case, such related EPC items are added to the virtual wallet of the Mobile User for cross-selling purposes. Targeting criteria (such as demographic information or other predictive analytics of the Mobile User of the linked mobile unit and possibly geolocation of the linked mobile unit) can be used to identify the related EPC items for targeting purposes.

The EPC items that are part of the virtual wallet of a Mobile User can be redeemed during a point-of-sale transaction via user-to-mobile unit interaction. In conjunction with checkout, the Mobile User interacts with the Cloud Service Application executing on the Mobile User's mobile unit to select one or more items of EPC, such as from a list of EPC items that make-up the virtual wallet of the Mobile User. After checkout is complete (i.e., the items or services for the point-of-sale transaction have been entered into a Networked POS Terminal), the Mobile User conveys an intent to interact with the Networked POS Terminal.

In one embodiment, the Mobile User conveys an intent to interact with the Networked POS Terminal by holding the mobile unit in his/her hand and performing a hand-based gesture (such as a wave or shake or flick) with the mobile unit held in that hand. The Cloud Service Application executing on the mobile unit includes a sensing system (e.g., accelerometer(s) together with accelerator monitoring and processing software) that automatically detects likely occurrence of the hand-based gesture. In response to the detection of the likely occurrence of the hand-based gesture by the Cloud Service Application executing on the mobile unit, the Cloud Service Application executing on the mobile unit issues a Meet-Me Request message to the Cloud Service utilizing networked communication. The Meet-Me Request message issued by the Cloud Service Application executing on the mobile unit includes data that identifies the user-selected items of EPC for the point-of-sale transaction. The Networked POS Terminal (possibly initiated by user input from a checkout clerk) also issues a Meet-Me Request message to the Cloud Service utilizing networked communication. The Meet-Me Request message issued by the Networked POS Terminal includes data (e.g., UPC codes or other product or service identifying codes) that identifies the items to be purchased by the Mobile User for the point-of-sale transaction.

The Meet-Me Request message pair that corresponds to a given interaction between a Mobile User and a Networked POS Terminal are communicated to the Cloud Service in an asynchronous manner. Moreover, in large scale deployments, there can be a number of Meet-Me Request message pairs corresponding to different interactions that are received at the Service at or near the same time. In order to address these issues, the Cloud Service includes logic that matches the received Meet-Me Request messages with spatial and temporal correlation processing in order to identify a logical connection or linkage (i.e., a one-to-one correspondence) between the Networked POS Terminal and the respective mobile unit.

In other embodiments, other contactless forms for interaction can be used to identify a logical connection or linkage (i.e., a one-to-one correspondence) between the Networked POS Terminal and the respective mobile unit.

In accordance with yet another aspect of the present application, in response to the identification of a logical connection or linkage (i.e., a one-to-one correspondence) between the Networked POS Terminal and the respective mobile unit by the Cloud Service, the Cloud Service dynamically matches zero or more user-selected items of EPC for the point-of-sale transaction (as encoded by the Meet-Me Request message issued from the mobile unit of the Mobile User) to the items to be purchased for the point-of-sale transaction (as encoded by the Meet-Me Request message issued from the Networked POS Terminal), applies the matching items of EPC to determine a price adjustment (i.e., a discount value) to the total purchase price for the point-of-sale transaction, and communicates the price adjustment to the linked Networked POS Terminal utilizing networked communication. The Networked POS Terminal receives the price adjustment communicated from the Cloud Service and applies such price adjustment to the price for the point-of-sale transaction. After payment is complete, the Networked POS Terminal issues a “transaction complete” message to the Cloud Service utilizing networked communication. The Cloud Service receives the “transaction complete” message and updates its database to reflect the redemption of the item(s) of EPC by the Mobile User as part of the point-of-sale transaction.

In another embodiment, in response to the identification of a logical connection or linkage (i.e., a one-to-one correspondence) between the Networked POS Terminal and the respective mobile unit by the Cloud Service, the Cloud Service communicates EPC data to the Networked POS Terminal using network communications. The EPC data represents the items of EPC that are part of the virtual wallet of the Mobile User of the linked mobile unit. The Networked POS Terminal receives the EPC data and uses the received EPC data to match the EPC items of the virtual wallet of the Mobile User to the items to be purchased for the point-of-sale transaction, applies the matching items of EPC to determine a price adjustment (i.e., a discount value) to the total purchase price for the point-of-sale transaction, and applies such price adjustment to the price for the point-of-sale transaction. After payment is complete, the Networked POS Terminal issues a “transaction complete” message to the Cloud Service utilizing networked communication. The Cloud Service receives the “transaction complete” message and updates its database to reflect the redemption of the item(s) of EPC by the Mobile User as part of the point-of-sale transaction.

In accordance with yet another aspect of the present application, the Cloud Service tracks the information stored in its database and generates real-time metrics for a given Promotional Campaign. The real-time metrics are based upon the information stored in its database that reflect the downloading of EPC items to Mobile Users as well as the redemption of EPC items by Mobile Users corresponding to the given Promotional Campaign. The Cloud Service also interacts with the Promoting Entity User operating the Promoting Entity system to report the real-time metrics to the Promoting Entity User and provide for real-time management of the Promotional Campaign by the Promoting Entity User (for example, after reviewing the real-time metrics).

Advantageously, the systems and methods of the present application provide for management of the networked distribution of EPC together with the ability to measure the effectiveness of the EPC to specific consumers as well as the efficacy of such distribution.

Moreover, the systems and methods of the present invention allow for distribution of EPC to be tied seamlessly to the display of information, such as an Ad, on a Networked Digital Sign, and to tie the redemption of EPC to the displayed information.

Moreover, the systems and methods of the present invention allow real-time measurement of Promotional Campaigns in order to provide a true understanding of the effectiveness of such multiple forms of such Promotional Campaigns.

### BRIEF DESCRIPTION OF THE DRAWINGS

The novel features believed characteristic of the invention are set forth in the appended claims. However, the invention itself, as well as a preferred mode of use, and further objectives and advantages thereof, will best be understood by reference to the following detailed description when read in conjunction with the accompanying drawings, wherein:

FIG. 1 illustrates an exemplary system providing for creating and managing Promotional Campaigns of Electronic Promotional Content (EPC), including networked distribution and redemption of such EPC;

FIGS. 2A and 2B, collectively, are a schematic illustration of an exemplary framework for registering Networked Digital Signs, Networked POS Terminals and Mobile Users that are part of the system of FIG. 1;

FIG. 3 is a schematic illustration of an exemplary framework for distributing EPC to Mobile Users in response to Mobile User interaction with his/her mobile unit of the system of FIG. 1;

FIGS. 4A and 4B, collectively, are a schematic illustration of an exemplary framework for distributing EPC to a Mobile User in response to the Mobile User conveying an intent to interact with a Networked Digital Sign of the system of FIG. 1;

FIGS. 5A and 5B, collectively, are a schematic illustration of an exemplary framework for a Mobile User redeeming items of EPC as part of a point-of-sale transaction involving a Networked POS Terminal of the system of FIG. 1 as well as tracking and reporting functions with respect to a Promotional Campaign involving such redemptions as part of the system of FIG. 1;

FIG. 5C is a schematic illustration of an alternate embodiment for parts of a framework for a Mobile User redeeming items of EPC as part of a point-of-sale transaction involving a Networked POS Terminal of the system of FIG. 1;

FIGS. 6A and 6B, collectively, are a flow chart illustrating exemplary operations of a Networked Digital Sign of the system of FIG. 1; the operations automatically detect a Mobile User's intent to interact with the Networked Digital Sign in conjunction with the contemporaneous (or nearly contemporaneous) display/playback of an Ad on the Networked Digital Sign, and automatically generate a Sign-to-Mobile Meet-Me Request for communication to the Cloud Service in response to such detection;

FIG. 6B is a flow chart illustrating exemplary operations of a Cloud Service Application executing on a mobile unit of FIG. 1; the operations automatically detect a Mobile User's intent to interact with the Networked Digital Sign, and automatically generates a Mobile-to-Sign Meet-Me Request for communication to the Cloud Service in response to such detection;

FIG. 6C1 and 6C2, collectively, are a flow chart illustrating exemplary operations of the Cloud Service (particularly, the Cloud Transaction Bridge) of FIG. 1 in processing Sign-to-Mobile Meet-Me Requests and Mobile-to-Sign Meet-Me Requests to determine a logical connection or link (i.e., a one-to-one correspondence) between a Networked Digital Sign and a mobile unit;

FIG. 7A is a flow chart illustrating exemplary operations of a Cloud Service Application executing on a mobile unit of FIG. 1; the operations automatically detect a Mobile User's intent to interact with the Networked POS Terminal, and automatically generates a Mobile-to-POS Meet-Me Request for communication to the Cloud Service in response to such detection;

FIGS. 7B1 and 7B2, collectively, are a flow chart illustrating exemplary operations of the Cloud Service (particularly, the Cloud Transaction Bridge) of FIG. 1 in processing POS-to-Mobile Meet-Me Requests and Mobile-to-POS Meet-Me Requests to determine a logical connection or link (i.e., a one-to-one correspondence) between a Networked POS Terminal and a mobile unit;

FIG. 8 illustrates an exemplary system providing electronic offer promotion redemption;

FIG. 9 illustrates an exemplary method of electronic offer promotion redemption; and

FIG. 10 illustrates an exemplary method of electronic content exchange via a digital display sign.

### DETAILED DESCRIPTION OF THE PREFERRED EMBODIMENTS

Reference will now be made to the following detailed description of the preferred and alternate embodiments of the present invention. Those skilled in the art will recognize that the present invention provides many inventive concepts and novel features, that are merely illustrative, and are not to be construed as restrictive. Accordingly, the specific embodiments discussed herein are given by way of example and do not limit the scope of the present invention.

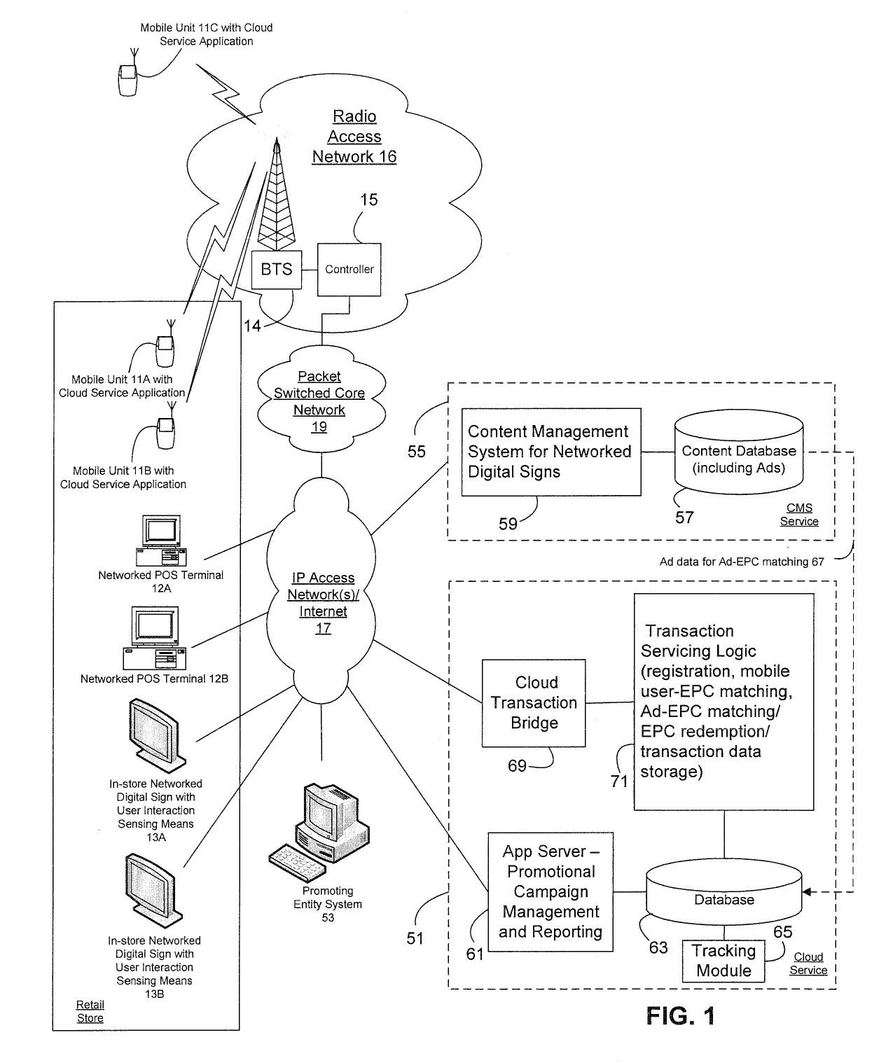

Turning now to FIG. 1, there is shown a schematic diagram of an exemplary system 1 which includes a Cloud Service 51 that provides shared resources (e.g., software logic and information) to the components of the system of FIG. 1 over a network (such as the Internet). Specifically, the Cloud Service 51 interfaces to a Promoting Entity system 53 utilizing networked communication (typically via messaging over a LAN/WAN(Internet)). The Promoting Entity system 53 is operated by a Promoting Entity User to interact with the Cloud Service 51 to provide for creation and management of Promotional Campaigns which specify items of EPC that are distributed to Mobile Users. The Promoting Entity system 53 can be realized by a networked computer (such as a personal computer, laptop, netbook, tablet, workstation, server, PDA, smartphone or other computing device) with a web browser or other suitable software for interacting the Cloud Service 51 utilizing networked communication.

The items of EPC of the Promotional Campaigns stored and managed by operation of the Cloud Service 51 are related to media content (such as Ads) displayed by one or more Networked Digital Signs (for example, in-store Networked Digital Signs 13A, 13B shown in FIG. 1) under control of a CMS Service 55. For example, the items of EPC can be related to the media content displayed by Networked Digital Signs 13A, 13B by product or service, by product or service type, by manufacturer or distributor or service provider, or by some other relationship. The Networked Digital Signs interface to the CMS Service 55 utilizing network communication (typically via messaging over a LAN/WAN(Internet)) to receive and store media content communicated from the CMS Service 55. The CMS Service 55 includes a content database 57 that stores media content (including Ads) that are supplied to the Networked Digital Signs 13A, 13B by system 59. The Networked Digital Signs can display/play the supplied media content (e.g., Ads) according to a predetermined schedule dictated by system 59.

The system also includes mobile units (for example three shown as 11A, 11B, 11C) that are each loaded with an application (referred to as the “Cloud Service Application”) that executes on the respective mobile unit. The Cloud Service Application can be an installed application or possibly software (such as an ActiveX control, or Silverlight control, or Java applet, or html/javascript interface or the like) that is accessible form a web site or wap site. The Cloud Service Application executing on the respective mobile unit interfaces to Cloud Service 51 utilizing networked communication (typically via messaging over a Radio Access Network and a WAN(Internet)) to provide for distribution of items of EPC related to the Promotional Campaigns managed by the Cloud Service 51 to mobile units for access by Mobile Users.

The Cloud Service 51 includes a database 63 that stores electronic information (referred to herein as a “virtual wallet”) for each Mobile User. The virtual wallet for a respective Mobile User represents items of EPC that are associated with the respective Mobile User. The items of EPC can be requested by the respective Mobile User or otherwise transferred to the respective Mobile User (for example, automatically transferred by the Cloud Service 51 in conjunction with a Promotional Campaign managed by the Cloud Service 51). The Cloud Service Application executing on a respective mobile unit can cooperate with the Cloud Service 51 using networked communication to allow the Mobile User to query the Cloud Service 51 for items of EPC that are stored in the database 62 as part of the virtual wallet of the Mobile User and to display or otherwise access one or more items of EPC of the virtual wallet of the Mobile User.

The Cloud Service Application executing on the mobile unit of a respective Mobile User can also cooperate with the Cloud Service 51 to allow for automatic distribution of items of EPC to the virtual wallet of the respective Mobile User in response to interaction between the respective Mobile User and a Networked Digital Sign (for example, one of the Networked Digital Signs 13A, 13B of FIG. 1). The interaction between the Mobile User and the Networked Digital Sign conveys an intent to interact by the Mobile User. It is contemplated that the Mobile User will convey an intent to interact while viewing an Ad displayed on the Networked Digital Sign, and the automatic distribution of EPC to the virtual wallet of the Mobile User adds zero or more items of EPC that are of interest to the Mobile User to the virtual wallet of the Mobile User. The added item(s) of EPC are thus accessible as part of the virtual wallet of the Mobile User through network communications with the Cloud Service 51.

In one embodiment, the interaction between the Mobile User and the Networked Digital Sign involves the Mobile User holding the mobile unit in his/her hand and performing a hand-based gesture (such as a wave or shake or flick) with the mobile unit held in that hand. The Networked Digital Sign includes a sensing system (e.g., one or more image-based sensors and suitable imaging processing software) that automatically detects likely occurrence of the hand-based gesture. In response to the detection of the likely occurrence of the hand-based gesture by the Networked Digital Sign, the Networked Digital Sign issues a Meet-Me Request message to the Cloud Service 51 utilizing networked communication (typically via messaging over the LAN/WAN(Internet)). The Cloud Service Application executing on the mobile unit also includes a sensing system (e.g., integral accelerometer(s) as well as accelerometer monitoring and processing software) that automatically detects the likely occurrence of the hand-based gesture. In response to the detection of the likely occurrence of the hand-based gesture by the Cloud Service Application executing on the mobile unit, the Cloud Service Application executing on the mobile unit issues a Meet-Me Request message to the Cloud Service 51 utilizing networked communication (typically via messaging over the LAN/WAN(Internet)).

The Meet-Me Request message pair that corresponds to a given interaction between a Mobile User and a Networked Digital Sign are communicated to the Cloud Service in an asynchronous manner. Moreover, in large scale deployments, there can be a number of Meet-Me Request message pairs corresponding to different interactions that are received at the Cloud Service at or near the same time. In order to address these issues, the Cloud Service 51 includes logic that matches the received Meet-Me Request messages with spatial and temporal correlation processing in order to identify a logical connection or linkage (i.e., a one-to-one correspondence) between the Networked Digital Sign and the respective mobile unit (particularly, a logical connection between the Networked Digital Sign the Cloud Service Application executing on the respective mobile unit). The correlation processing can also correlate parameters of the hand gestures sensed by the Networked Digital Signs and mobile units in order to identify the a logical connection or linkage (i.e., a one-to-one correspondence) between the Networked Digital Sign and the respective mobile unit (particularly, a logical connection between the Networked Digital Sign the Cloud Service Application executing on the respective mobile unit).

In other embodiments, other contactless forms for interaction can be used to identify a logical connection or linkage (i.e., a one-to-one correspondence) between the Networked Digital Sign and the respective mobile unit (particularly, a logical connection between the Networked Digital Sign the Cloud Service Application executing on the respective mobile unit). For example, near field communication between the Networked Digital Sign and the respective mobile unit can be used to identify such logical connection or linkage. In other example, bar code display on the Networked Digital Sign (or on the mobile unit of the Mobile User) and bar-code scanning on the mobile unit of the Mobile User (or on the Networked Digital Sign) can be used to identify such logical connection or linkage. In yet other example, an audio tone or audio message output by a Networked Digital Sign can be used to identify such logical connection or linkage. In still yet another example, a unique identifier printed or displayed on a Networked Digital Sign can be used to identify such logical connection or linkage. In still yet another example, the display of a unique identifier and SMS short code on a Networked Digital Sign and corresponding texting of the unique identifier to the SMS short code by the Mobile User on the mobile unit can be used to identify such logical connection or linkage.

In response to the identification of a logical connection or linkage (i.e., a one-to-one correspondence) between a Networked Digital Sign and the respective mobile unit, the Cloud Service 51 dynamically identifies zero or more items of EPC that are related to the particular information displayed on the Networked Digital Sign at or near the time of issuance of the Meet-Me Request message from the Networked Digital Sign to the Cloud Service 51, and then communicates such item(s) of EPC to the virtual wallet of the Mobile User of the respective mobile unit for user access via the Cloud Service Application executing on the respective mobile unit. In one embodiment, the Meet-Me Request message issued by the Networked Digital Sign includes data (such as an identifier or other meta-data) related to the particular Ad displayed on the Networked Digital Sign at or near the time of issuance of the Meet-Me request from the Networked Digital Sign to the Cloud Service 51. The Cloud Service 51 uses such data to dynamically identify zero or more items of EPC that are related to the particular Ad for distribution of such item(s) of EPC to the virtual wallet of the Mobile User respective mobile unit. The Cloud Service 51 can also dynamically identify EPC items that are not directly related to particular Ad, but instead are complimentary or related in some other manner to the products of the particular Ad. In this case, such related EPC items are communicated to the respective mobile unit for cross-selling purposes. Targeting criteria (such as demographic information or other predictive analytics of the Mobile User of the linked mobile unit and/or possibly geolocation of the linked mobile unit) can be used to identify the related EPC items for targeting purposes.

The EPC items that are part of the virtual wallet of a Mobile User can be redeemed during a point-of-sale transaction via user-to-mobile unit interaction. For example, in the retail environment, the Mobile User can collect one or more items to be purchased while walking through the retail store and approach a Networked POS Terminal (for example, Networked POS Terminal 12A) for checkout. The checkout clerk (or possible the Networked POS Terminal 12A itself for self-checkout systems) scans or otherwise enters the items into the Networked POS Terminal 12A. In conjunction with checkout, the Mobile User interacts with the Cloud Service Application to select one or more items of EPC, such as from a list of EPC items that make up the virtual wallet of the Mobile User and displayed on the respective mobile unit. In other environments, during the point-of-sale transaction, the Mobile User interacts with the Cloud Service Application to select one or more items of EPC, for example from a list of EPC items that make up the virtual wallet of the Mobile User and displayed on the respective mobile unit.

After checkout is complete (i.e., the items or services for the point-of-sale transaction have been entered into the Networked POS Terminal 12A), the Mobile User conveys an intent to interact with the Networked POS Terminal 12A. In one embodiment, the Mobile User conveys an intent to interact with the Networked POS Terminal 12A by holding the mobile unit in his/her hand and performing a hand-based gesture (such as a wave or shake or flick) with the mobile unit held in that hand. The Cloud Service Application executing on the mobile unit includes a sensing system (e.g., accelerometer(s) together with accelerator monitoring and processing software) that automatically detects likely occurrence of the hand-based gesture. In response to the detection of the likely occurrence of the hand-based gesture by the Cloud Service Application executing on the mobile unit, the Cloud Service Application executing on the mobile unit issues a Meet-Me Request message to the Cloud Service 51 utilizing networked communication (typically via messaging over a Radio Access Network and WAN(Internet)). The Meet-Me Request issued by the Cloud Service Application executing on the mobile unit includes data that identifies the user-selected items of EPC for the point-of-sale transaction. The Networked POS Terminal 12A also issues a Meet-Me request message to the Cloud Service 51 utilizing networked communication (typically via messaging over the LAN/WAN(Internet)). The Meet-Me request message issued by the Networked POS Terminal includes data (e.g., UPC codes or other product or service identifying codes) that identifies the items to be purchased by the Mobile User for the point-of-sale transaction.

The Meet-Me Request message pair that corresponds to a given interaction between a Mobile User and a Networked POS Terminal are communicated to the Cloud Service in an asynchronous manner. Moreover, in large scale deployments, there can be a number of Meet-Me Request message pairs corresponding to different interactions that are received at the Cloud Service at or near the same time. In order to address these issues, the Cloud Service 51 The Cloud Service 51 includes logic that matches the received Meet-Me Request messages with spatial and temporal correlation processing in order to identify a logical connection or linkage (i.e., a one-to-one correspondence) between the Networked POS Terminal 12A and the respective mobile unit (particularly, a logical connection or linkage between the Networked POS Terminal and the Cloud Service Application executing on the respective mobile unit). The correlation processing can also correlate the goods or services to be purchased with the items of EPC of the virtual wallet of the Mobile Users of the received Meet-me request messages in order to identify the a logical connection or linkage (i.e., a one-to-one correspondence) between the Networked Digital Sign and the respective mobile unit (particularly, a logical connection between the Networked Digital Sign the Cloud Service Application executing on the respective mobile unit).

In other embodiments, other contactless forms for interaction can be used to identify a logical connection or linkage (i.e., a one-to-one correspondence) between a respective Networked POS Terminal and a respective mobile unit (particularly, a logical connection or linkage between the Networked POS Terminal and the Cloud Service Application executing on the respective mobile unit). For example, near field communication between the Networked POS Terminal 12A and the mobile unit of the Mobile User can be used to identify such logical connection or linkage. In another example, bar code display on the POS Terminal 12A (or on the mobile unit of the Mobile User) and bar-code scanning on the mobile unit of the Mobile User (or on the POS Terminal 12A) can be used to identify such logical connection or linkage. In yet other example, an audio tone or audio message output by the POS Terminal can be used to identify such logical connection or linkage. In still yet another example, a unique identifier printed or displayed by the POS Terminal can be used to identify such logical connection or linkage. In still yet another example, the display of a unique identifier and SMS short code by the POS Terminal and corresponding texting of the unique identifier to the SMS short code by the Mobile User on the mobile unit can be used to identify such logical connection or linkage.

In response to the identification of a logical connection or linkage (i.e., a one-to-one correspondence) between a respective Networked POS Terminal and a respective mobile unit, the Cloud Service 51 dynamically matches zero or more user-selected items of EPC for the point-of-sale transaction (as encoded by the Meet-Me Request message issued from the respective mobile unit of the Mobile User) to the items to be purchased for the point-of-sale transaction (as encoded by the Meet-Me Request message issued from the respective Networked POS Terminal), and communicates data representing the matching item(s) of EPC to the linked Networked POS Terminal utilizing networked communication (typically via messaging over the LAN/WAN(Internet)). The Networked POS Terminal receives the item(s) of EPC communicated from the Cloud Service 51 and applies such item(s) of EPC to the transaction as appropriate (which typically results in a reduction of the total price) and then completes payment of the transaction (such as by cash, credit card processing, debit card processing or other payment processing methods). After payment is complete, the respective Networked POS Terminal issues a “transaction complete” message to the Cloud Service 51 utilizing networked communication (typically via messaging over the LAN/WAN(Internet)). The “transaction complete” message which includes data that identifies the item(s) of EPC that were redeemed by the Mobile User as part of the point-of-sale transaction. The Cloud Service 51 receives the “transaction complete” message and updates its database to reflect the redemption of the item(s) of EPC by the Mobile User as part of the point-of-sale transaction.

In another embodiment, in response to the identification of a logical connection or linkage (i.e., a one-to-one correspondence) between the Networked POS Terminal and the respective mobile unit by the Cloud Service, the Cloud Service 51 communicates EPC data to the Networked POS Terminal using networked communication. The EPC data represents the items of EPC that are part of the virtual wallet of the Mobile User of the linked mobile unit. The Networked POS Terminal receives the EPC data and uses the received EPC data to match the EPC items of the virtual wallet of the Mobile User to the items to be purchased for the point-of-sale transaction, applies the matching items of EPC to determine a price adjustment (i.e., a discount value) to the total purchase price for the point-of-sale transaction, and applies such price adjustment to the price for the point-of-sale transaction. After payment is complete, the Networked POS Terminal issues a “transaction complete” message to the Cloud Service 51 utilizing networked communication. The Cloud Service receives the “transaction complete” message and updates its database to reflect the redemption of the item(s) of EPC by the Mobile User as part of the point-of-sale transaction.

The Cloud Service 51 tracks the information stored in its database and generates real-time metrics for a given Promotional Campaign. The real-time metrics are based upon the information stored in its database that reflect the downloading of EPC items to Mobile Users as well as the redemption of EPC items by Mobile Users corresponding to the given Promotional Campaign. The Cloud Service also interacts with the Promoting Entity User operating the Promoting Entity system to report the real-time metrics to the Promoting Entity User and provide for real-time management of the Promotional Campaign by the Promoting Entity User (for example, after reviewing the real-time metrics).

In one embodiment, the Cloud Service 51 includes app server logic 61 for presenting a graphical user interface to the Promoting Entity System 53 that enables the Promoting Entity User to create and review a list of Promotional Campaigns of the Promoting Entity User and perform a variety of tasks related thereto. Each Promotional Campaign is represented by information stored in database 63. The information includes one or more items of EPC that is intended to be distributed to Mobile Users as well as other information. Alternatively, the database 63 can store references (such as URLs) to the items of EPC for the Promotional Campaign. Such references can be used to for network access and retrieval of EPC as needed by the elements of the system.

The Cloud Service 51 also includes a tracking module 65 that derives statistical metrics (such as, for example, goals for number of EPC items transferred to Mobile Users and/or viewed by Mobile Users and/or redeemed by Mobile Users (per campaign, program and/or date), costs, redemption rates, percentage of redeemers that are incremental customers, etc.) specific to each Promotional Campaign. The tracking module 65 monitors updates to the data stored in the database 63 for each Promotional Campaign, generates the metrics in real time and formats the metrics in real-time such the metrics are accessible by the Promoting Entity User in real-time on the graphical user interface presented by the app server logic 61. The metrics can be presented to the Promoting Entity User for a specific Promotional Campaign (or group of Promotional Campaigns) as well as for individual items of EPC of the Promoting Entity User.

One of the tasks supported by the app server logic 61 of the Cloud Service 51 includes creating and managing Promotional Campaigns of the Promoting Entity User, which preferably enables the Promoting Entity User to specify and update one or more of the following information items:
name of the Promotional Campaign;
the start date and the end date of the Promotional Campaign;
data for targeting the items of EPC for the Promotional Campaign, such as demographics, psychographics, and/or other predictive analytics;
metrics for the Promotional Campaign (e.g., goals for number of EPC items transferred to Mobile Users and/or viewed by Mobile Users and/or redeemed by Mobile Users (per campaign, program and/or date), costs, redemption rates, percentage of redeemers that are incremental customers, etc.)
one or more items of EPC for the Promotional Campaign (or references to such items of EPC;
information that relates items of EPC of the Promotional Campaign to Ads managed by the CMS; this information can be derived from data supplied from the CMS Service 55 as evidenced by data flow 67; and
information that relates items of EPC of the Promotional Campaign to certain retail stores, manufactures, product or service names or categories, or other keywords or meta-data.
   The information of the Promotional Campaign(s) of the Promoting Entity User is stored in the database 63.

The database 63 also stores information pertaining to Mobile Users of the system 1 of FIG. 1, which can include some or all of the following for each respective Mobile User:
Contact Information (such as, Name, Mobile Number, Short Name, Email Address);
Demographic information (such as birth date/age, gender, family size, income, occupation, religion, education, nationality or race, eye color, favorite pet, etc.);
the virtual wallet of the Mobile User (e.g., a list of active EPC items that have been transferred to the Mobile User)
List of redeemed EPC items;
user profile information for targeting (such as, shopping habits, shopping history, etc.)

The mobile units 11A, 11B, 11C of the system 1 can be any of a number of mobile communication devices including cellular handset devices, personal digital assistants, tablet computers, netbook computers, laptop computers, etc. Such devices typically support wireless communication over a cell-based radio access network 16 that includes base stations and corresponding controllers (one pair shown as 14 and 15) that interface to a packet switched core network 16 which is connected to an IP access network and the Internet 17.

The communication network(s) 16, 19, 17 as well as the operating system of the mobile units 11A, 11B, 11C can provide support for the TCP/IP networking and suitable messaging protocols in order communicate messages between the mobile units 11A, 11B, 11C and the Cloud Service 51. Similarly, the operating system of the Networked Digital Signs 13A, 13B can provide support for the TCP/IP networking and suitable messaging protocols in order communicate messages between the Networked Digital Signs 13A, 13B and the Cloud Service 51, and the operating system of the Networked POS Terminals 12A, 12B can provide support for the TCP/IP networking and suitable messaging protocols in order to communicate messages between the Networked POS Terminals 12A, 12B and the Cloud Service 51. Those skilled in the art will recognize that the complete structure and operation of communication networks and other components within the system 1 are not depicted or described. Embodiments may be employed in conjunction with known communications networks and other components.

In one embodiment, the Cloud Service 51 includes a Cloud Transaction Bridge 69 that provides for messaging between the mobile units 11A, 11B, 11C and the Cloud Service 51, for messaging between the Networked Digital Signs 13A, 13B and the Cloud Service 51 as well as for messaging between the Networked POS Terminals 12A, 12B and the Cloud Service 51. The Cloud Transaction Bridge 69 also processes the Meet-Me Request messages from the elements of the system 1 and matches the received Meet-Me Request messages with spatial and temporal correlation processing in order to identify a logical connection or linkage (i.e., a one-to-one correspondence) between the requesting elements of the system 1. The Cloud Transaction Bridge 69 can also function to dynamically match zero or more user-selected items of EPC that are part of the virtual wallet of a Mobile User (as encoded by a Meet-Me Request message issued from the mobile unit of the Mobile User) to the items to be purchased for a point-of-sale transaction (as encoded by the Meet-Me Request message issued from a linked Networked POS Terminal) to determine a price adjustment for the point-of-sale transaction. Alternatively, the Cloud Transaction Bridge 69 can communicate the EPC items of the virtual wallet of the Mobile User to the Networked POS Terminal such that the Networked POS Terminal can process the EPC items and determine and apply a price adjustment for the transaction, if any.

The Cloud Transaction Bridge 69 interfaces to Transaction Servicing Logic 71 over a private application programming interface. The Transaction Servicing Logic 71 is responsible for accessing the database 63 to support user registration, mobile user querying for items of EPC that make up the virtual wallet of the Mobile User, dynamic matching of zero or more items of EPC stored in the database 63 to an Ad (or other content) displayed on the Networked Digital Signs 13A, 13B and/or to a particular Mobile User (for targeting purposes), redemption of items of EPC as part of point-of-sale transactions, and storage of transaction data in the database 63.

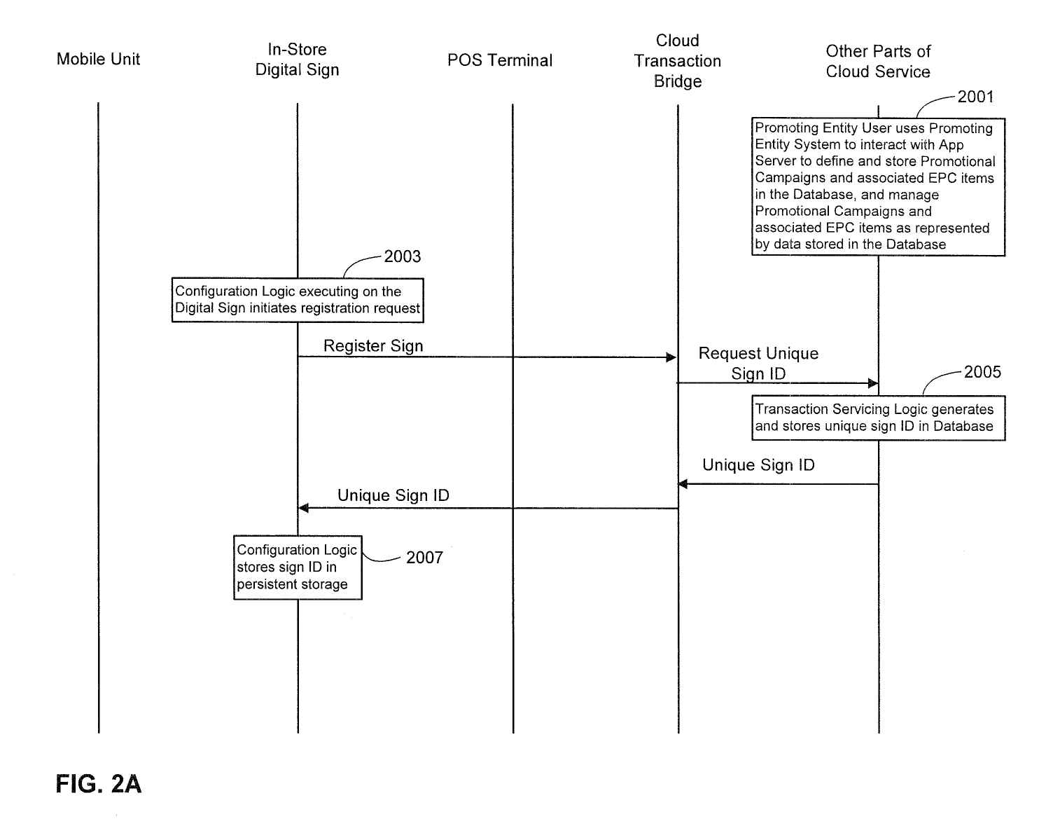

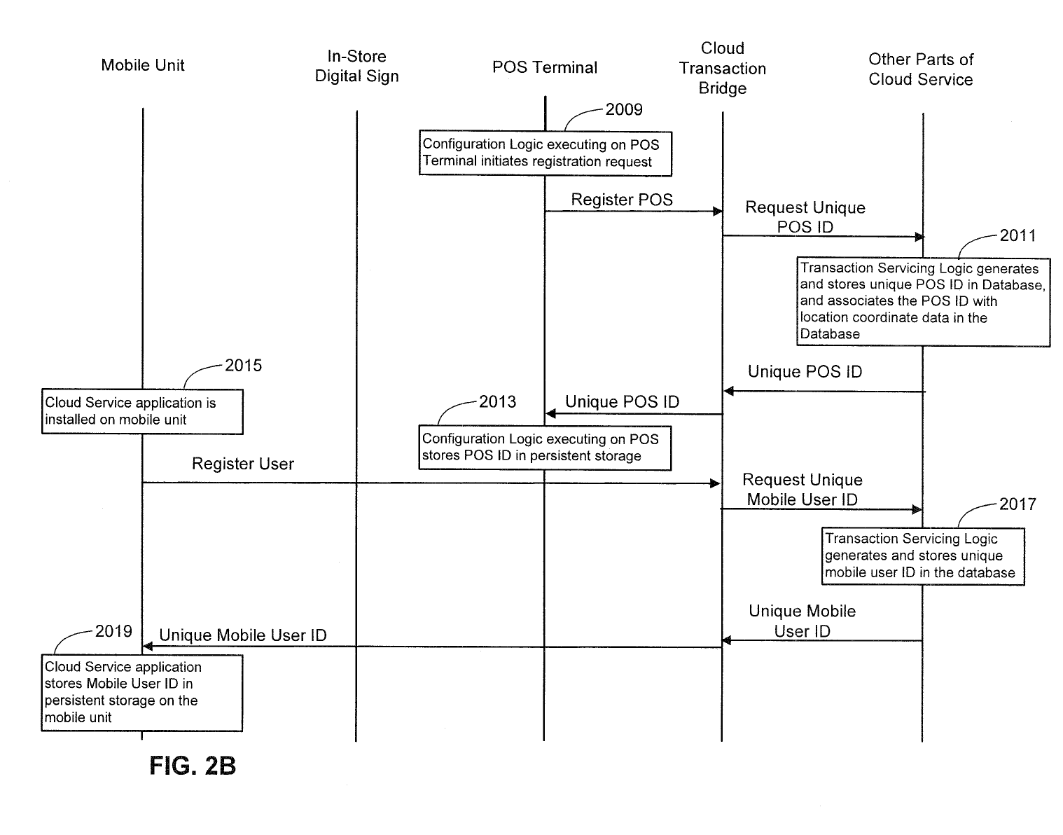

FIGS. 2A-5B are schematic illustrations of a framework whereby Cloud Service provides for creation and management of Promotional Campaigns and the mobile units, Networked Digital Signs, Networked POS Terminals, Cloud Transaction Bridge, and other parts of the Cloud Service cooperate to provide for networked distribution and redemption of Electronic Promotional Content that is part of such Promotional Campaigns.

Turning to FIG. 2A, in block 2001, a Promoting Entity User uses the Promoting Entity System 53 to interact with the app server logic 61 of the Cloud Service 51 using networked communications (via messaging over the IP Access Network/Internet 17) to define and store Promotional Campaigns and associated EPC items in the database 63, and to manage Promotional Campaigns and associated EPC items as represented by data stored in the database 63. The Promotional Campaigns specify items of EPC that are distributed to Mobile Users as described below.

In block 2003, configuration logic executing on each respective Networked Digital Sign (for example two shown as 13A, 13B in FIG. 1) of the system 1 initiates a Digital Sign registration request message (labeled “Register Sign” in FIG. 2A), which is communicated to the Cloud Transaction Bridge 69 of the Cloud Service 51 using networked communications (via messaging over the IP Access Network/Internet 17). The Cloud Transaction Bridge 69 receives the Digital Sign registration request message communicated from the respective Networked Digital Sign and issues a corresponding Digital Sign registration request message (labeled “Request Unique Sign ID”) to the Transaction Servicing Logic 71 of the Cloud Service 51. In Block 2005, in the event that this is the first time that the Networked Digital Sign has registered, the Transaction Servicing Logic 71 generates a unique sign ID for the Networked Digital Sign in response to receipt of this message, stores the unique Sign ID (and possibly other data for the Networked Digital Sign such as the store identifier, geolocation data for the Networked Digital Sign, and a unique hardware identifier (such as MAC address) for the Networked Digital Sign) in the database 63, and returns the unique Sign ID to the Cloud Transaction Bridge 69, which returns the unique Sign ID to the respective Networked Digital Sign. In the event that the Networked Digital Sign has already registered, the logic 71 finds the already-existing registration record for the Networked Digital Sign and returns the unique Sign ID stored in the record and does not create a new record. In block 2007, the configuration logic of the respective Networked Digital Sign stores the unique Sign ID returned from the Cloud Transaction Bridge 69 in persistent storage. This unique Sign ID will be used in subsequent messages to identify the source of the message as the respective Networked Digital Sign.

In block 2009, configuration logic executing on each respective Networked POS Terminal (for example, two shown as 12A, 12B in FIG. 1) of the system 1 initiates a POS Terminal registration request message (labeled “Register POS” in FIG. 2B), which is communicated to the Cloud Transaction Bridge 69 of the Cloud Service 51 using networked communications (via messaging over the IP Access Network/Internet 17). The Cloud Transaction Bridge 69 receives the POS Terminal registration request message communicated from the respective Networked POS Terminal and issues a corresponding POS Terminal registration request message (labeled “Request Unique POS ID”) to the Transaction Servicing Logic 71 of the Cloud Service 51. In Block 2011, in the event that this is the first time that the Networked POS Terminal has registered, the Transaction Servicing Logic 71 generates a unique POS ID for the Networked POS Terminal in response to receipt of this message, stores the unique POS ID (and possibly other data for the Networked POS Terminal such as the store ID, geolocation data for the Networked POS Terminal, and a unique hardware identifier (such as MAC address) for the Networked POS Terminal) in the database 63, and returns the unique POS ID to the Cloud Transaction Bridge 69, which returns the unique POS ID to the respective Networked POS Terminal. In the event that the Networked POS Terminal has already registered, the logic 71 finds the already-existing registration record for the Networked POS Terminal and returns the unique Sign ID stored in the record and does not create a new record. In block 2013, the configuration logic of the respective Networked POS Terminal stores the unique POS ID returned from the Cloud Transaction Bridge 69 in persistent storage. This unique POS ID will be used in subsequent messages to identify the source of the message as the respective Networked POS Terminal.

In block 2015, the Cloud Service Application is installed or otherwise loaded for execution on the respective mobile unit of one or more Mobile Users. The Cloud Service Application can be an installed application or possibly software (such as an ActiveX control or Silverlight control or Java applet or the like) that is accessible form a web site. The Cloud Service Application may be discovered and installed or otherwise loaded for execution onto the mobile unit in any one of a number of ways, such as:
a Mobile User discovers the Cloud Service Application while browsing through the application icons, or through the pre-installed applications, on his or her mobile unit's menu; or
a Mobile User discovers the Cloud Service Application displayed on a Web site, a Wap site, or other mechanism for public distribution therefrom; promoted in text or instant message or on a client application; promoted on an traditional-media advertisement (print, TV or radio); or promoted on a remote vending terminal (e.g. a WiFi or Bluetooth kiosk). The user selects the Cloud Service Application, which results in the application being downloaded onto the user's device where it will automatically installed or otherwise loaded for execution on the mobile unit.

After loading the Cloud Service Application on a respective mobile unit, the first time that the Cloud Service Application is executed on the mobile unit (or possible some other event or time) triggers an initialization process where the Cloud Service Application initiates a Mobile User registration request message (labeled “Register User” in FIG. 2B), which is communicated from the Cloud Service Application executing on the mobile unit to the Cloud Transaction Bridge 69 of the Cloud Service 51 using networked communications (via messaging over the Radio Access Network 16, the Packet Switched Core Network 19 and the IP Access Network/Internet 17). The Cloud Transaction Bridge 69 receives the Register User registration request message communicated from the Cloud Service Application executing on the mobile unit and issues a corresponding Mobile User registration request message (labeled “Request Unique Mobile User ID”) to the Transaction Servicing Logic 71 of the Cloud Service 51. In Block 2017, in the event that this is the first time that the Mobile User has registered, the Transaction Servicing Logic 71 generates a unique Mobile User ID for the Mobile User in response to receipt of this message, stores the unique Mobile User ID in the database 63, and returns the unique Mobile User ID to the Cloud Transaction Bridge 69, which returns the unique Mobile User ID to the Cloud Service Application executing on the mobile unit. In the event that the Mobile User has already registered, the logic 71 finds the already-existing registration record for the Mobile User and returns the unique Mobile User ID stored in the record and does not create a new record. In block 2019, the Cloud Service Application executing on the mobile unit stores the unique Mobile User ID returned from the Cloud Transaction Bridge 69 in persistent storage. This unique Mobile User ID will be used in subsequent messages to identify the source of the message as the respective Mobile User.

It is contemplated that the initialization process (or some other registration process) can collect additional data for the Mobile User (such as contact information, demographic information and possibly other information for the Mobile User). This additional data is also stored in the database 63.

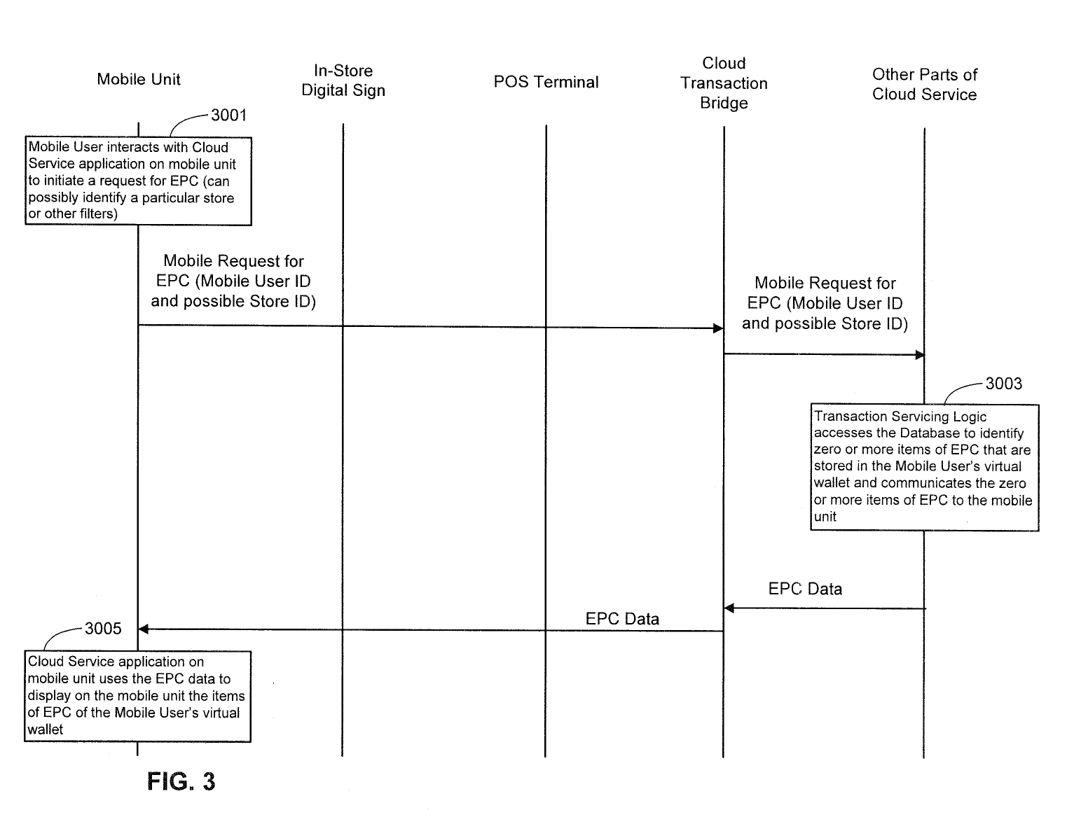

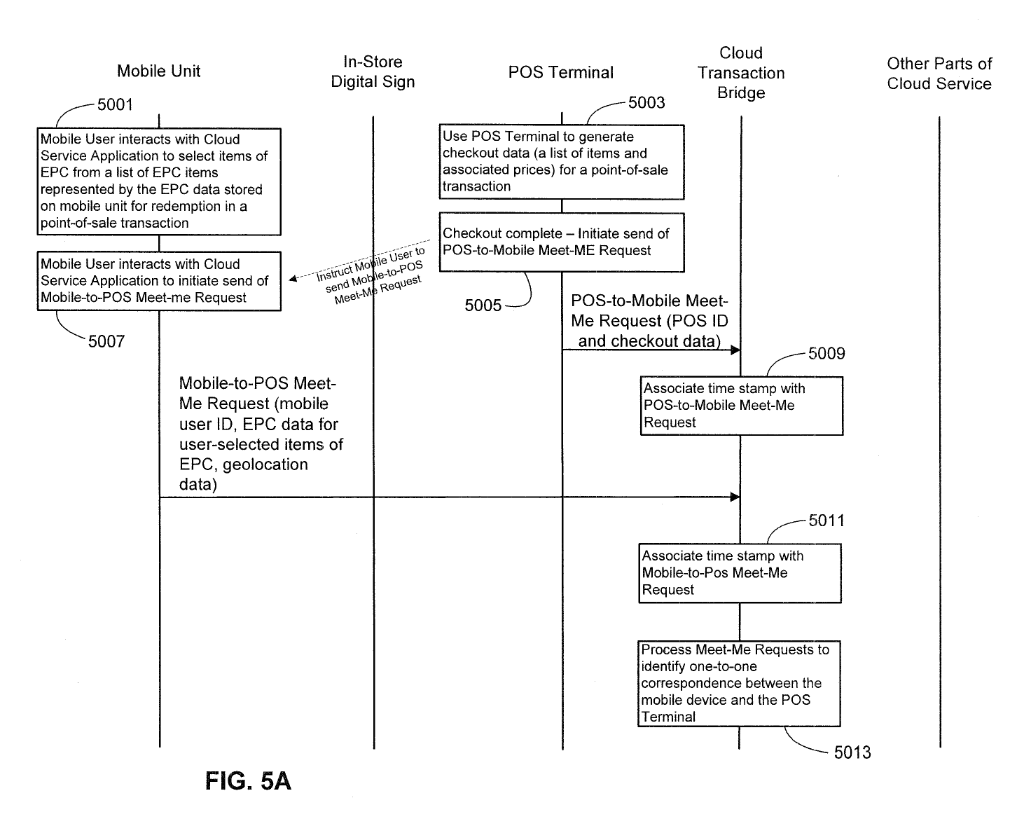

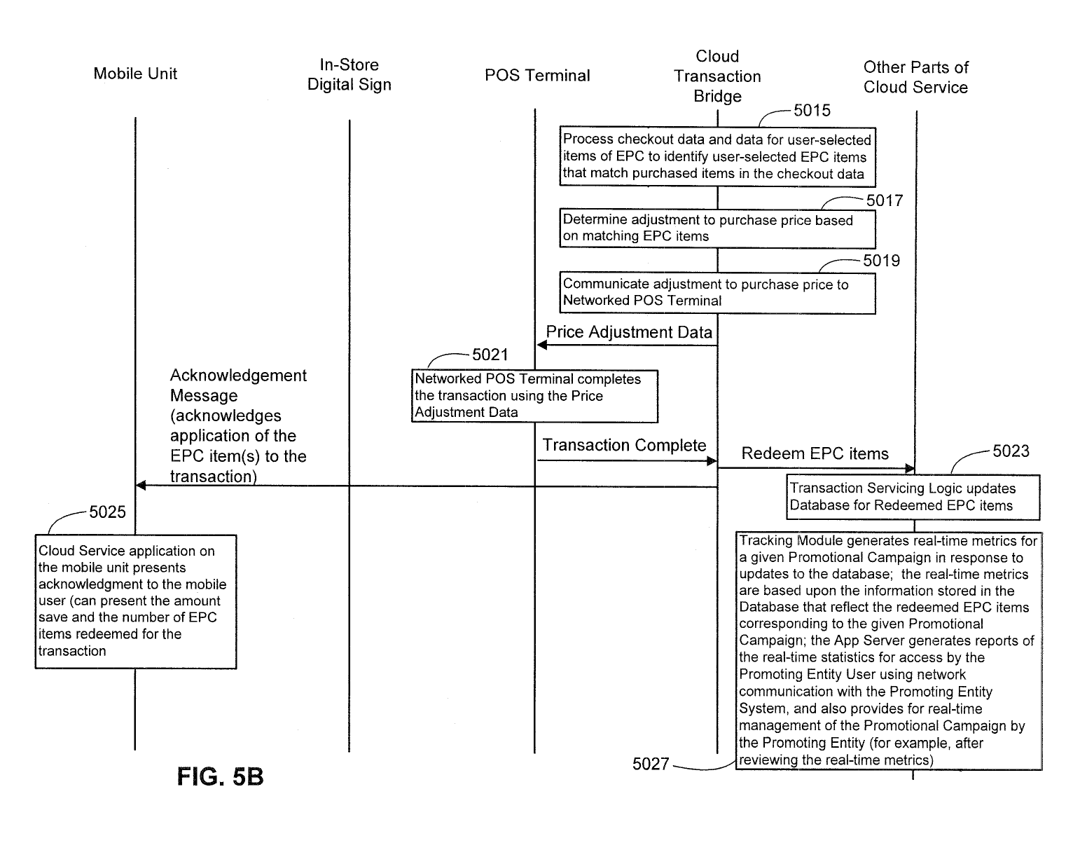

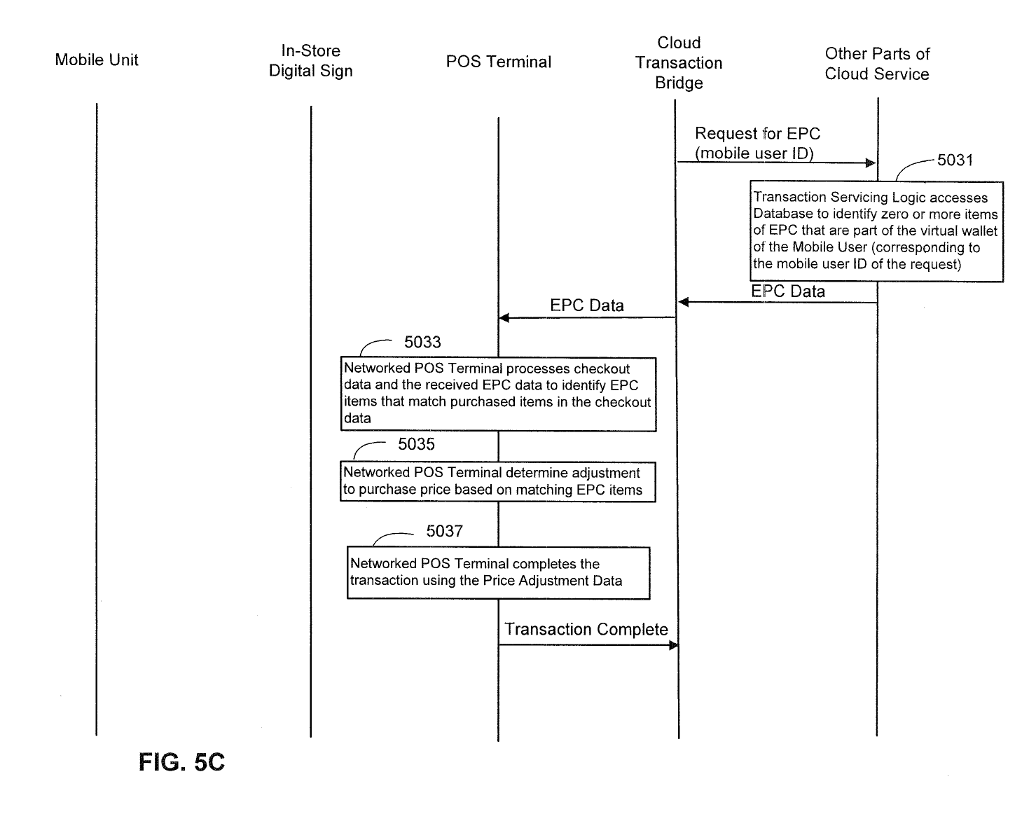

Turning to FIG. 3, it is assumed that the Mobile User has installed or otherwise loaded the Cloud Service Application on his/her mobile unit and performed the initialization process described above with respect to FIG. 2B. In block 3001, the Mobile User invokes execution of the Cloud Service Application on his/her mobile unit (if need be) and interacts with the Cloud Service Application executing on the mobile unit to query the Cloud Service 51 for items of EPC that are part of the virtual wallet of the Mobile User as represented by the information stored in the database 63. The query is labeled “Mobile Request for EPC” in FIG. 3 and can include the Mobile User ID for the Mobile User and possible other data for servicing the query. Such other data can be a store identifier that identifies a particular retail store (such as for the case where the Mobile User has identified a particular retail store from multiple retail stores or where the Cloud Service Application is branded for a particular retail store). The query is communicated from the Cloud Service Application executing on the mobile unit to the Cloud Transaction Bridge 69 using networked communications (via messaging over the Radio Access Network 16, the Packet Switched Core Network 19 and the IP Access Network/Internet 17). The Cloud Transaction Bridge 69 receives the query communicated from the Cloud Service Application executing on the mobile unit and issues a corresponding query message (labeled “Mobile Request for EPC”, which can include the Mobile User ID for the Mobile User and possible other data for servicing the query) to the Transaction Servicing Logic 71 of the Cloud Service 51. In block 3003, the Transaction Servicing Logic 71 searches the database 63 to identify zero or more items of EPC that match the query (for example, match the Store ID and are part of the virtual wallet for the Mobile User corresponding to the Mobile User ID of the query), and returns data representing the matching zero or more EPC items (labeled “EPC data”) to the Cloud Transaction Bridge 69, which returns the data representing the matching zero or more EPC items (labeled “EPC data”) to the Cloud Service Application executing on the mobile unit. In block 3005, the Cloud Service Application executing on the mobile unit displays data representing the matching zero or more EPC items as encoded by the EPC data returned from the Cloud Transaction Bridge 69. Such items of EPC data that are stored in the virtual wallet of the Mobile User can be selected by the mobile user and redeemed in subsequent point-of-sale transactions (FIGS. 5A-5B).

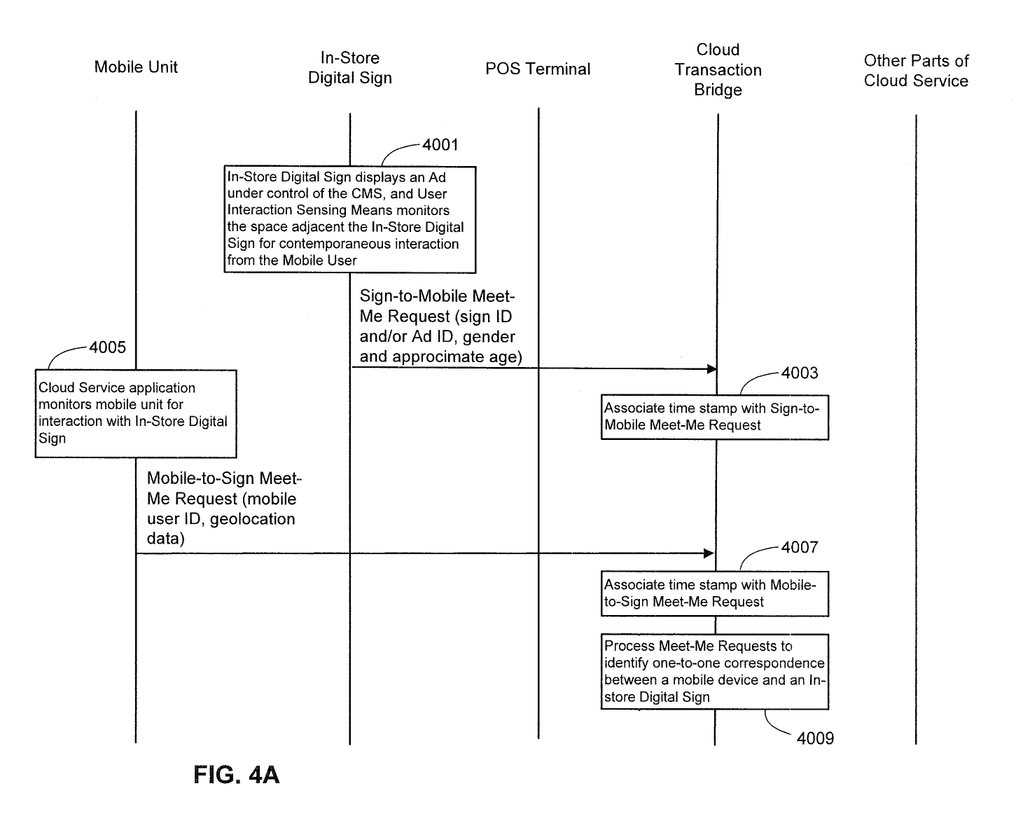

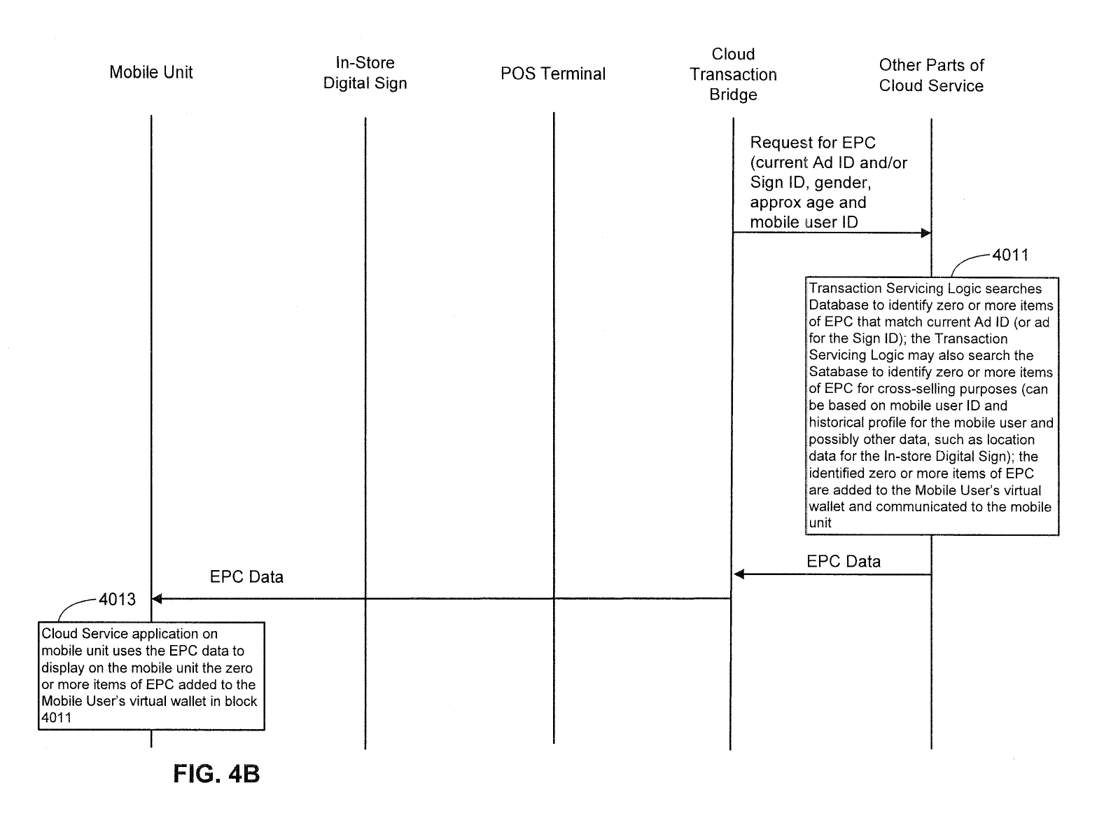

Turning to FIG. 4A, it is assumed that the Mobile User has installed or otherwise loaded the Cloud Service Application on his/her mobile unit and has performed the initialization process described above with respect to FIG. 2B, and the Cloud Service Application is executing on the mobile unit of a Mobile User. The Mobile User interacts with any one of the Networked Digital Signs (13A or 13B) by holding the mobile unit in his/her hand and performing a hand-based gesture (such as a wave or shake or flick) with the mobile unit held in that hand. In block 4001, a respective Networked Digital Sign (13A or 13B) displays an Ad under control of the CMS Service 55, and the respective Networked Digital Sign includes User Interaction Sensing Means that is adapted to monitor the space adjacent the respective Networked Digital Sign for interaction from the Mobile User. The User Interaction Sensing Means is preferably realized by an image-based sensor (such as the Kinect sensor available from Microsoft Corporation of Redmond, Wash.) and appropriate image processing software that automatically detects the likely occurrence of a hand-based gesture by the Mobile User (such as the KinectSDK available from Microsoft Corporation of Redmond, Wash. for skeleton tracking and software that recognizes the hand-based gesture from the skeleton tracking output). In the event that the User Interaction Sensing Means detects the likely occurrence of the hand-based gesture by an interacting user, the respective Networked Digital Sign is adapted to automatically initiate a Meet-Me Request message (labeled “Sign-to-Mobile Meet-Me Request” in FIG. 4A), which is communicated to the Cloud Transaction Bridge 69 of the Cloud Service 51 using networked communications (via messaging over the IP Access Network/Internet 17). The Cloud Transaction Bridge 69 receives the Sign-to-Mobile Meet-Me Request message communicated from the Networked Digital Sign and associates a time stamp with the received Sign-to-Mobile Meet-Me Request message in block 4003. The Sign-to-Mobile Meet-Me Request can include the sign ID for the Digital Sign that issued the request, an Ad ID or other identifier for the Ad that was displayed/played at or near the time of the recognition of the hand-based gesture, and possibly parameters for the detected gesture for correlation purposes.

Contemporaneous with the processing of block 4001, in block 4005 the Cloud Service Application executing on the mobile unit of the Mobile User monitors the output of sensors (such as accelerometers) integral to the mobile unit in order to automatically detect the likely occurrence of the hand-based gesture. In response to the automatic detection of the likely occurrence of the hand-based gesture by the Cloud Service Application executing on the mobile unit, the Cloud Service Application is adapted to automatically initiate a Meet-Me Request message (labeled “Mobile-to-Sign Meet-Me Request” in FIG. 4A), which is communicated to the Cloud Transaction Bridge 69 of the Cloud Service 51 using networked communications (via messaging over the Radio Access Network 16, Packet Switched Core Network 19 and IP Access Network/Internet 17). The Cloud Transaction Bridge 69 receives the Mobile-to-Sign Meet-Me Request message communicated from the mobile unit and associates a time stamp with the received Mobile-to-Sign Meet-Me Request message in block 4007. The Mobile-to-Sign Meet-Me Request can include the Mobile User ID for the Mobile User of the mobile unit that issued the request, geolocation data of the mobile unit (output from the GPS and/or other geolocation services integral to the mobile unit at or near the time of the detection of the likely occurrence of the hand-based gesture), and possibly parameters for the detected gesture for correlation purposes.

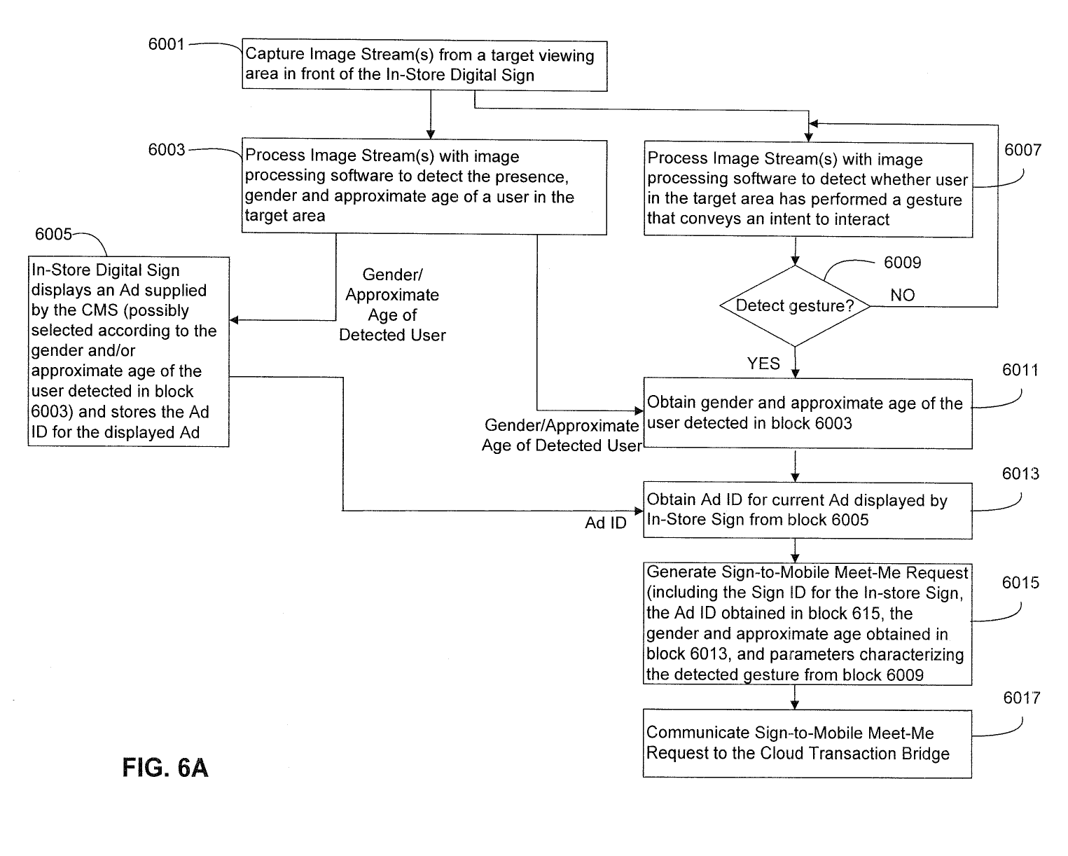

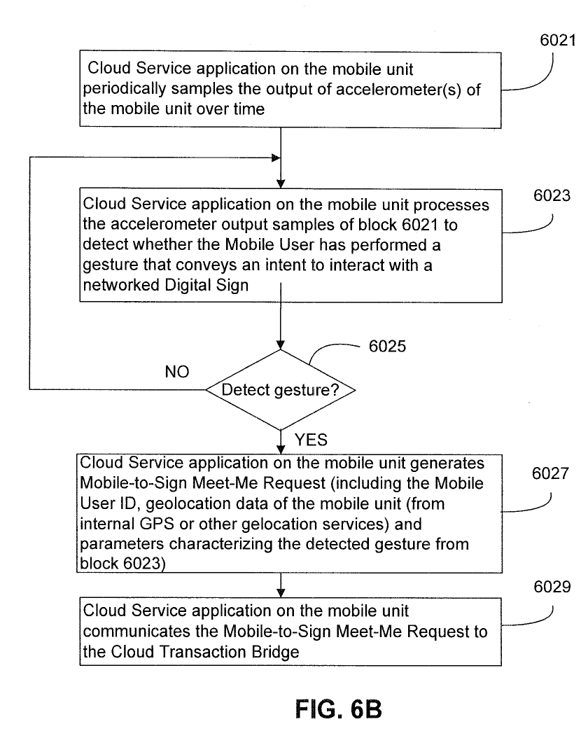

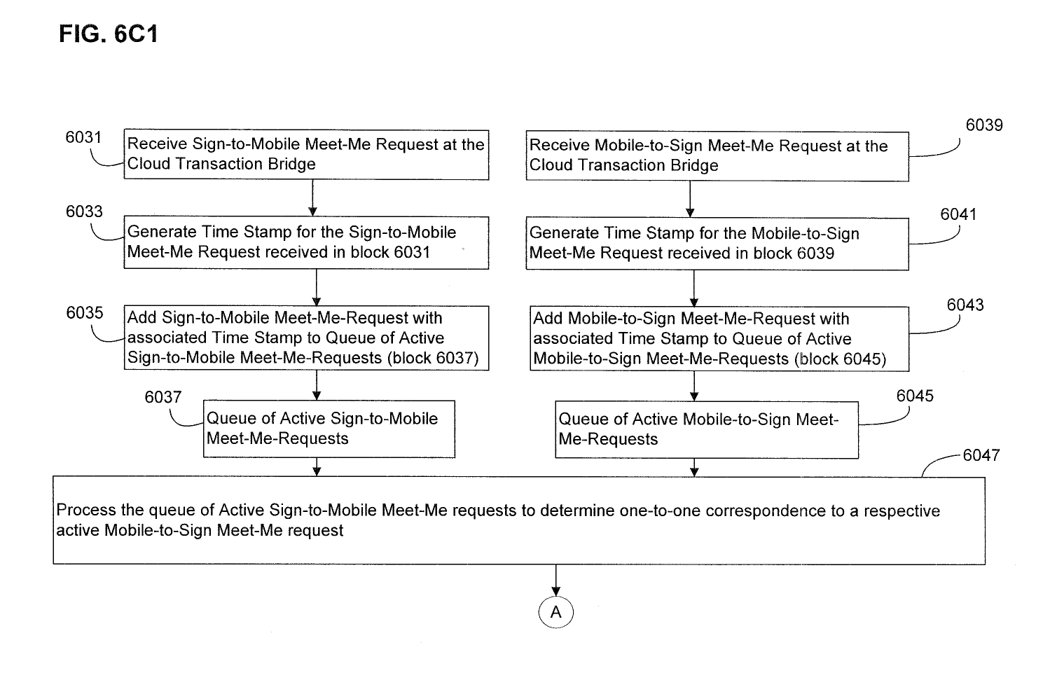

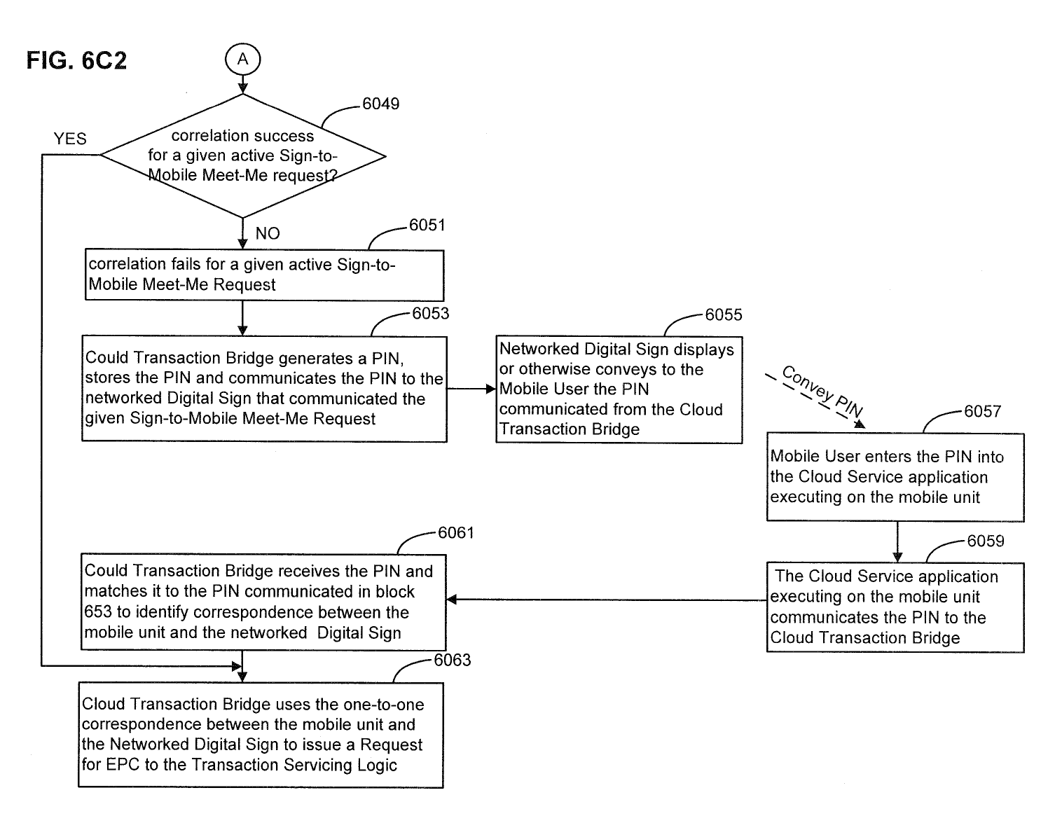

The Sign-to-Mobile and Mobile-to-Sign Meet-Me Request message pair that corresponds to a given interaction between a Mobile User and a Networked Digital Sign are communicated to the Cloud Transaction Bridge 69 in an asynchronous manner. Moreover, in large scale deployments, there can be a number of Meet-Me Request message pairs corresponding to different interactions that are received at the Cloud Transaction Bridge 69 at or near the same time. In order to address these issues, in block 4009, the Cloud Transaction Bridge 69 processes the received Sign-to-Mobile Meet-Me Requests and Mobile-to-Sign Meet-Me Requests with spatial and temporal correlation processing in order to identify a logical connection or linkage (i.e., a one-to-one correspondence) between the Networked Digital Sign and the Cloud Service Application executing on the respective mobile unit. Details of exemplary correlation processing is described below with respect to FIGS. 6C1 and 6C2.

In response to the identification of a logical connection or linkage (i.e., a one-to-one correspondence) between a Networked Digital Sign and the Cloud Service Application executing on a respective mobile unit, the Cloud Transaction Bridge 69 issues a request to the Transaction Servicing Logic 71 (labeled “Meet-Me Request for EPC”), which includes the Ad ID and/or Sign ID or other identifier for the Ad that was displayed/played at or near the time of the recognition of the hand-based gesture by the corresponding Networked Digital Sign, the approximate age and gender of the Mobile User as derived by the Networked Digital Sign, and the Mobile User ID of the corresponding mobile unit. The Transaction Servicing Logic 71 searches the database 63 to dynamically identify zero or more items of EPC that is related to the particular Ad displayed on the corresponding Networked Digital Sign (as identified by the Ad identifier of the request) and adds such item(s) of EPC to the virtual wallet of the Mobile User (which corresponds to the Mobile User ID of the request). The Transaction Service Logic 71 also communicates EPC Data which represents such item(s) of EPC to the Cloud Transaction Bridge, which communicates the EPC data to the corresponding mobile unit for user access via the Cloud Service Application executing on the respective mobile unit. It is also contemplated that in block 4011 the Transaction Servicing Logic 71 can also search the database 63 to dynamically identify EPC items that are not directly related to the particular Ad displayed on the corresponding Networked Digital Sign (as identified by the Ad identifier of the request), but instead are complimentary or related in some other manner to the products of the particular Ad for cross-selling purposes. In this case, such related EPC items can be added to the virtual wallet of the Mobile User (which corresponds to the Mobile User ID of the request, and are returned as part of the EPC data to the Cloud Transaction Bridge for user access via the Cloud Service Application executing on the respective mobile unit. Targeting criteria (such as demographic information or other predictive analytics of the particular Mobile User and possibly geolocation of the mobile unit of the particular Mobile User) can be used to identify the related EPC items. The item(s) of EPC added to the virtual wallet of the Mobile User are available for future requests and access for redemption purposes.

In block 4013, the Cloud Service Application executing on the respective mobile unit uses the EPC data representing the matching zero or more EPC items (labeled “EPC data”) returned from the Cloud Transaction Bridge 69 to display on the mobile unit the zero or more EPC items added to the virtual wallet of the Mobile User in block 4011.

Turning to FIG. 5A, it is assumed that the Mobile User has installed or otherwise loaded the Cloud Service Application on his/her mobile unit, performed the initialization process described above with respect to FIG. 2B, and downloaded items of EPC for storage on the mobile unit as described above with respect to FIGS. 3A-3B and/or 4A-4B.

In block 5001, the Mobile User interacts with the Cloud Service Application executing on the mobile unit to select items of EPC for redemption as part of a point-of-sale transaction, for example from a list of EPC items that make up the virtual wallet of the User as displayed on the mobile unit.

In block 5003, a Networked POS Terminal (12A or 12B) is used to generate checkout data, which includes a list of items and associated prices for the point-of-sale transaction.

In block 5005, after checkout is complete (i.e., the items or services for the point-of-sale transaction have been entered into the Networked POS Terminal), the POS clerk (or the POS Terminal itself for self-checkout systems) instructs the Mobile User to issue a Meet-Me Request message by conveying an intent to interact with the Networked POS Terminal, which can be conveyed by holding the mobile unit in his/her hand and performing a hand-based gesture (such as a wave or shake or flick) with the mobile unit held in that hand. It can also be conveyed by a predetermined user input on the mobile unit (such as a clicking or pressing on a predetermined button or some other user input event).

After instructing the Mobile User, the checkout clerk interacts with the Networked POS Terminal (or the Networked POS Terminal operates by itself for self-checkout systems) to issue a Meet-Me Request message (labeled “POS-to-Mobile Meet-Me Request” in FIG. 5A), which is communicated to the Cloud Transaction Bridge 69 of the Cloud Service 51 using networked communications (via messaging over the IP Access Network/Internet 17). The Cloud Transaction Bridge 69 receives the POS-to-Mobile Meet-Me Request message communicated from the Networked POS Terminal and associates a time stamp with the received POS-to-Mobile Meet-Me Request message in block 5011. The POS-to-Mobile Meet-Me Request message issued by the Networked POS Terminal includes data (e.g., UPC codes or other product or service identifying codes) that identifies the items to be purchased by the Mobile User for the point-of-sale transaction.

In block 5007, the Cloud Service Application executing on the mobile unit monitors the output of sensors (such as accelerometers) integral to the mobile unit in order to automatically detect the likely occurrence of the hand-based gesture. In response to the automatic detection of the likely occurrence of the hand-based gesture by the Cloud Service Application executing on the mobile unit, the Cloud Service Application is adapted to automatically initiate a Meet-Me Request message (labeled “Mobile-to-POS Meet-Me Request” in FIG. 5A), which is communicated to the Cloud Transaction Bridge 69 of the Cloud Service 51 using networked communications (via messaging over the Radio Access Network 16, Packet Switched Core Network 19 and IP Access Network/Internet 17). The Cloud Transaction Bridge 69 receives the Mobile-to-POS Meet-Me Request message communicated from the mobile unit and associates a time stamp with the received Mobile-to-POS Meet-Me Request message in block 5009. The Mobile-to-POS Meet-Me Request can include the Mobile User ID for the Mobile User of the mobile unit that issued the request, geolocation data of the mobile unit (output from the GPS or other geolocation services integral to the mobile unit at or near the time of the detection of the likely occurrence of the hand-based gesture). The Cloud Service Application executing on the mobile unit can also be adapted to automatically initiate a Mobile-to-POS Meet-Me Request message in response to predetermined user input on the mobile unit (such as a clicking or pressing on a predetermined button or some other user input event).

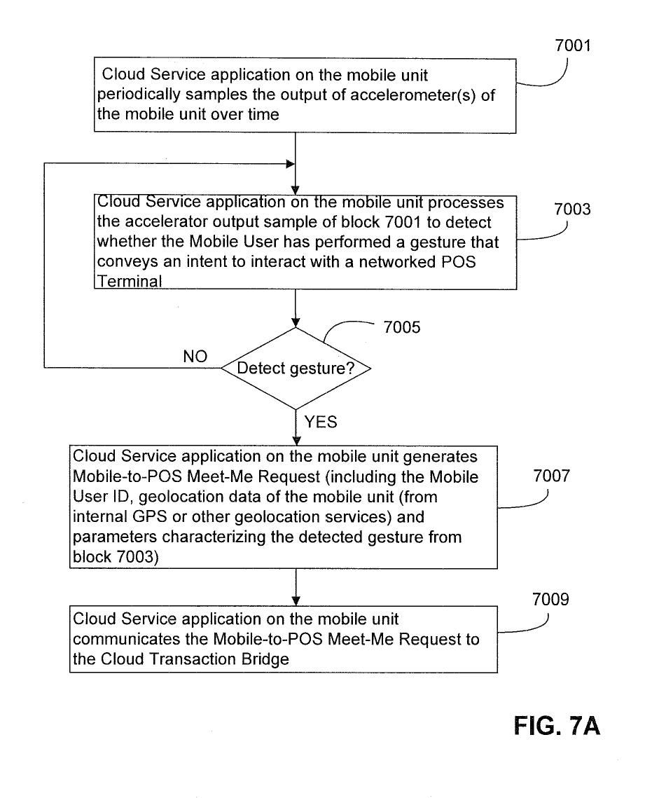

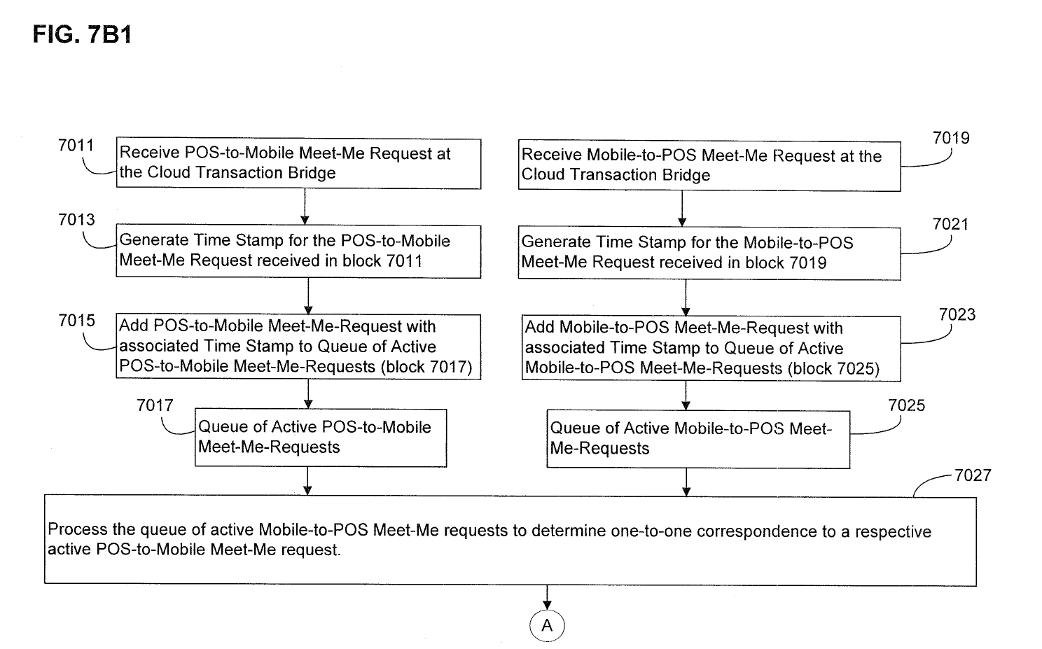

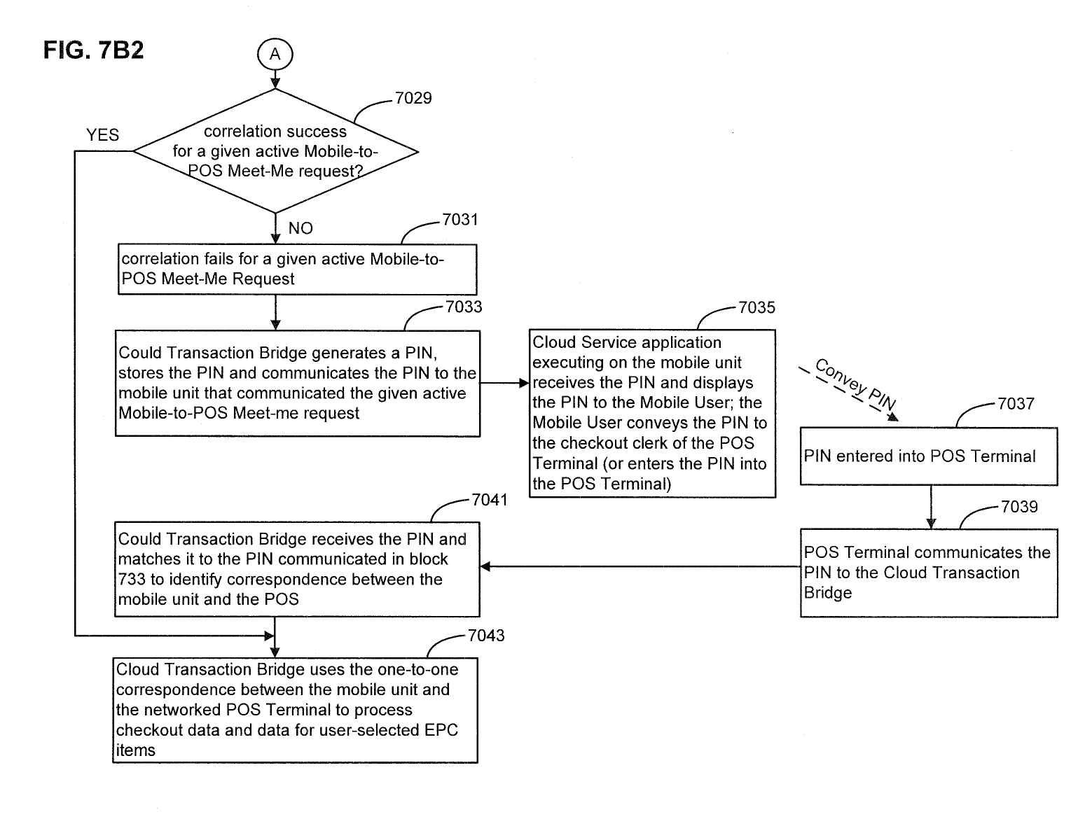

The Mobile-to-POS and POS-to-Mobile Meet-Me Request message pair that corresponds to a given interaction between a Mobile User and a Networked POS Terminal are communicated to the Cloud Transaction Bridge 69 in an asynchronous manner. Moreover, in large scale deployments, there can be a number of Meet-Me Request message pairs corresponding to different interactions that are received at the Cloud Transaction Bridge 69 at or near the same time. In order to address these issues, in block 5013, the Cloud Transaction Bridge 69 processes the received POS-to-Mobile Meet-Me Requests and Mobile-to-POS Meet-Me Requests with spatial and temporal correlation processing in order to identify a logical connection or linkage (i.e., a one-to-one correspondence) between the Networked POS Terminal and a respective mobile unit (particularly, a logical connection or linkage between the Networked POS Terminal and the Cloud Service Application executing on the respective mobile unit). Details of exemplary correlation processing is described below with respect to FIGS. 7B1 and 7B2.

In block 5015, in response to the identification of a logical connection or linkage (i.e., a one-to-one correspondence) between a Networked POS Terminal and the respective mobile unit, the Cloud Transaction Bridge 69 dynamically matches zero or more user-selected items of EPC for the point-of-sale transaction (as encoded by the Mobile-to-POS Meet-Me Request message issued from the corresponding mobile unit) to the items to be purchased for the point-of-sale transaction (as encoded by the POS-to-Mobile Meet-Me request message issued from the corresponding Networked POS Terminal).

In block 5017, the Cloud Transaction Bridge 69 calculates an adjustment (i.e., a price discount) to the total purchase price for the point-of-sale transaction based on the matching EPC items determined in block 5015.

In block 5019, the Cloud Transaction Bridge 69 communicates data representing the adjustment calculated in block 5017 (labeled “Price Adjustment Data”) to the corresponding Networked POS Terminal using networked communications (via messaging over the IP Access Network/Internet 17).

In block 5021, the Networked POS Terminal receives the Price Adjustment Data communicated from the Cloud Transaction Bridge 69 and applies the price adjustment encoded therein to the transaction as appropriate (which typically results in a reduction of the total price) and then completes payment of the transaction (such as by cash, credit card processing, debit card processing or other payment processing methods). After payment is complete, the Networked POS Terminal issues a message (labeled “Transaction Complete”) to the Cloud Transaction Bridge 69 using networked communications (via messaging over the IP Access Network/Internet 17).

In block 5023, the Cloud Transaction Bridge 69 receives the Transaction Complete message issued by the Networked POS Terminal and issues a message (labeled “Redeem EPC Items”) to the Transaction Servicing Logic 71. The Redeem EPC Items message includes data that identifies the item(s) of EPC that were redeemed by the Mobile User as part of the point-of-sale transaction and identified in block 5015. The Cloud Transaction Bridge 69 also issues a message (labeled “Acknowledgement Message”) to the corresponding mobile unit, which is communicated using networked communications (via messaging over IP Access Network/Internet 17, Packet Switched Core Network 19, and the Radio Access Network 16). The Acknowledgement Message includes information for acknowledging the redemption of the item(s) of EPC as part of the point-of-sale transaction. Such information can include the number of items of EPC that were redeemed as well as the amount saved for the transaction.

In block 5023, the Transaction Servicing Logic 71 receives the Redeem EPC Items message communicated from the Cloud Transaction Bridge 69 and updates the database 63 to reflect the redemption of the item(s) of EPC by the Mobile User as encoded by the Redeem EPC Items message.

In block 5025, Cloud Service Application executing on the mobile unit of the Mobile User receives the Acknowledgement message communicated from the Cloud Transaction Bridge 69 in block 5019 and presents to the Mobile User an acknowledgement of the redemption of the item(s) of EPC as encoded in the Acknowledgement message. The information presented to the Mobile User can include the number of items of EPC that were redeemed as well as the amount saved for the transaction.

In block 5027, the Tracking Module 63 generates real-time metrics for a given Promotional Campaign in response to updates to the database 63 (block 5019). The real-time metrics are based upon the information stored in the database 63 that reflect the redeemed EPC items corresponding to the given Promotional Campaign. Furthermore, the app server logic 61 can generate reports of the real-time statistics for access by the Promoting Entity User using network communication with the Promoting Entity system 53. The app server logic 61 can also provide for real-time management of the Promotional Campaign by the Promoting Entity user (for example, after reviewing the reported real-time metrics).

FIG. 5C illustrates an alternate embodiment for processing point-of-sale transactions where the functions of blocks 5015 to 5021 of FIG. 5B are substituted with the functions of blocks 5031 to 5037 as shown. In in response to the identification of a logical connection or linkage (i.e., a one-to-one correspondence) between a Networked POS Terminal and the respective mobile unit by the Cloud Transaction Bridge 69 in block 5013, the Cloud Transaction Bridge 69 issues a message (labeled “Request for EPC”, which can include the Mobile User ID for the Mobile User) to the Transaction Servicing Logic 71 of the Cloud Service 51. In block 5031, the Transaction Servicing Logic 71 searches the database 63 to identify zero or more items of EPC that are part of the virtual wallet for the Mobile User corresponding to the Mobile User ID of the request, and returns data representing the matching zero or more EPC items (labeled “EPC data”) to the Cloud Transaction Bridge 69, which returns the data representing the matching zero or more EPC items (labeled “EPC data”) to the Networked POS Terminal. The EPC data represents the items of EPC that are part of the virtual wallet of the Mobile User of the linked mobile unit.

In block 5033, the Networked POS Terminal receives the EPC data and uses the received EPC data to identify the EPC items of the virtual wallet of the Mobile User that match the items to be purchased for the point-of-sale transaction.

In block 5035, the Networked POS Terminal applies the matching items of EPC as identified in block 5033 to calculate a price adjustment (i.e., a discount value) to the total purchase price for the point-of-sale transaction.

In block 5037, the Networked POS Terminal applies the price adjustment calculated in block 5035 to the price for the point-of-sale transaction. After payment is complete, the Networked POS Terminal issues a “Transaction Complete” message to the Cloud Service 51 utilizing networked communication. The Cloud Service receives the “Transaction Complete” message and the processing continues as described above with respect to FIG. 5B, which involves an update to database 63 to reflect the redemption of the item(s) of EPC by the Mobile User as part of the point-of-sale transaction.

FIG. 6A illustrates exemplary functionality of a Networked Digital Sign (13A or 13B) in generating a Sign-to-Mobile Meet-Me Request message as described above with respect to FIG. 4A. In block 6001, the User Interaction Sensing Means of the Networked Digital Sign captures one or more image streams of a target viewing area in front of the Networked Digital Sign. The image stream capture of block 6001 can be provided by an image-based sensor (such as the Kinect sensor available from Microsoft Corporation of Redmond, Wash.).

In block 6003, the image stream(s) captured in block 6001 are processed with image processing software to the automatically detect the presence, gender and approximate age of a user in the target area. The image processing of block 6003 can be provided by the Intel AIM Suite, which is distributed commercially by Intel Corporation of Santa Clara, Calif.

In block 6005, the Networked Digital Sign plays/displays an Ad under control of the CMS Service 55. The Ad can possibly be selected according to the gender and/or the approximate age of the user detected in block 6003. In block 6005, the Networked Digital Sign stores the Ad ID for the played/displayed Ad on the Networked Digital Sign.

In block 6007, the image stream(s) captured in block 6001 are processed with image processing software to the automatically detect the likely occurrence of a hand-based gesture by a Mobile User. The image processing of block 6007 can be provided by video analytic software, such as the KinectSDK available from Microsoft Corporation of Redmond, Wash. for skeleton tracking and software for recognition of the hand-based gesture from the skeleton tracking output.

In block 6009, the Networked Digital Sign determines whether the image processing of block 6007 has detected the likely occurrence of a hand-based gesture by a Mobile User. If not, the operations return to block 6007. If so, the operations continue to block 6011.

In block 6011, the Networked Digital Sign obtains the gender and approximate age of the user detected in block 6003.

In block 6013, the Networked Digital Sign obtains the Ad ID for the current Ad played/displayed by the Networked Digital Sign.

In block 6015, the Networked Digital Sign generates a Sign-to-Mobile Meet-Me Request message for communication to the Cloud Transaction Bridge 69 using networked communications (via messaging over the IP Access Network/Internet 17). The Sign-to-Mobile Meet-Me Request message includes the Sign ID for the Networked Digital Sign, the Ad ID obtained in block 6013, the gender and approximate age obtained in block 6011, and possibly parameters characterizing the detected gesture from block 6007.

In block 6017, the Sign-to-Mobile Meet-Me Request message generated in block 6015 is communicated from the Networked Digital Sign to the Cloud Transaction Bridge 69 using networked communications (via messaging over the IP Access Network/Internet 17).

FIG. 6B illustrates exemplary functionality of a mobile unit (11A or 11B) in generating a Mobile-to-Sign Meet-Me Request message as described above with respect to FIG. 4A. In block 6021, the Cloud Service Application executing on the mobile unit periodically samples the output of accelerometer(s) of the mobile unit over time.

In block 6023, the Cloud Service Application on the mobile unit processes the accelerometer output samples of block 6021 to detect whether the Mobile User has performed a gesture that conveys an intent to interact with a Networked Digital Sign. Such processing involves detecting gesture as a sequence of significant movements of the device that match predefined gesture patterns that indicate a consumer's intent to interact with the Networked Digital Sign.

In block 6025, the Cloud Service Application on the mobile unit determines whether the processing of block 6023 has detected the likely occurrence of a hand-based gesture by a Mobile User. If not, the operations return to block 6023. If so, the operations continue to block 6027.

In block 6027, the Cloud Service Application on the mobile unit generates a Mobile-to-Sign Meet-Me Request message for communication to the Cloud Transaction Bridge 69 using networked communications (via messaging over the Radio Access Network 16, the Packet Switch Core Network 19 and the IP Access Network/Internet 17). The Mobile-to-Signe Meet-Me Request message includes the Mobile User ID (stored in the mobile unit (FIG. 2B), geolocation data of the mobile unit output from the internal GPS or other geolocation services of the mobile unit, and possibly parameters characterizing the detected gesture from block 6025.

In block 6029, the Mobile-to-Sign Meet-Me Request message generated in block 6027 is communicated from the mobile unit to the Cloud Transaction Bridge 69 using networked communications (via messaging over the Radio Access Network 16, the Packet Switch Core Network 19 and the IP Access Network/Internet 17).

FIG. 6C1 and 6C2 illustrate exemplary functionality of the Cloud Transaction Bridge 69 in processing Mobile-to-Sign Meet-Me Request messages and Sign-to-Mobile Meet Me Request messages to determine a logical connection or link (i.e., a one-to-one correspondence) between a Networked Digital Sign and a respective mobile unit.

In block 6031, the Cloud Transaction Bridge 69 receives the Sign-to-Mobile Meet-Me Request. In block 6033, the Cloud Transaction Bridge 69 generates a time stamp for the Sign-to-Mobile Meet-Me Request received in block 6031. In block 6035, the Cloud Transaction Bridge 69 adds the Sign-to-Mobile Meet-Me-Request received in block 6031 together with its associated time stamp generated in block 6033 to a Queue of Active Sign-to-Mobile Meet-Me-Requests (block 6037).

In block 6039, the Cloud Transaction Bridge 69 receives the Mobile-to-Sign Meet-Me Request. In block 6041, the Cloud Transaction Bridge 69 generates a time stamp for the Mobile-to-Sign Meet-Me Request received in block 6039. In block 6043, the Cloud Transaction Bridge 69 adds the Mobile-to-Sign Meet-Me-Request received in block 6039 together with its associated time stamp generated in block 6041 to a Queue of Active Mobile-to-Sign Meet-Me-Requests (block 6045).

The Sign-to-Mobile and Mobile-to-Sign Meet-Me Request message pair that corresponds to a given interaction between a Mobile User and a Networked Digital Sign are communicated to the Cloud Transaction Bridge 69 in an asynchronous manner. Moreover, in large scale deployments, there can be a number of Meet-Me Request message pairs corresponding to different interactions that are received at the Cloud Transaction Bridge 69 at or near the same time. In order to address these issues, in block 6047, the Cloud Transaction Bridge 69 processes the queue of Active Sign-to-Mobile Meet-Me Requests to determine one-to-one correspondence to a respective active Mobile-to-Sign Meet-Me Request. The processing of block 6047 involves a hierarchical three tier correlation scheme involving spatial and temporal correlation processing:
first-tier correlation—the geolocation data of the respective active Mobile-to-Sign Meet-Me Request corresponds to the location of the store as derived from the Store ID of the respective active Sign-to-Mobile Meet-Me Request;
second tier correlation—the time stamp of the respective active Mobile-to-Sign Meet-Me Request falls within a time window corresponding to the time stamp for the respective active Sign-to-Mobile Meet-Me Request; and
third tier correlation—pattern analysis results of the gesture parameters of the respective active Mobile-to-Sign Meet-Me Request is compared to pattern analysis results of the gesture parameters for the respective active Sign-to-Mobile Meet-Me Request.
   The correlations provide a confidence level. Multiple algorithms can be used to generate a number of confidence levels. Weighting factors can be used to combine the confidence levels. The resultant confidence level is compared against a threshold to indicate a correspondence. The satisfaction of the first and second tiers of correlation identify one-to-one correspondence between a respective active Mobile-to-Sign Meet-Me Request and a respective active Sign-to-Mobile Meet-Me-Request in the event that there are no other possible queued Meet-Me Request pairs that share the respective active Mobile-to-Sign Meet-Me request or the respective active Sign-to-Mobile Meet-Me Request (i.e., there is no collision between a number of queued Meet-Me Request pairs). In the event there is such a collision, the third-tier correlation is used to resolve the collision conditions.

In block 6049, the Cloud Transaction Bridge 69 determines whether there is correlation success for a given active Sign-to-Mobile Meet-Me Request in the processing of block 6047. If so, the operations continue to block 6063. In the event that the correlation fails for a given active Sign-to-Mobile Meet-Me Request (block 6051), the operations continue to blocks 6053 to 6061 to carry out a PIN exchange method that provides a logical connection or link (i.e., a one-to-one correspondence) between a Networked Digital Sign and a respective mobile unit.

In block 6053, the Cloud Transaction Bridge generates a PIN, stores the PIN and communicates the PIN to the Networked Digital Sign that communicated the given active Sign-to-Mobile Meet-Me Request using networked communications (via messaging over the IP Access Network/Internet 17).

In block 6055, the Networked Digital Sign receives the PIN and displays the PIN (or otherwise conveys the PIN such as in an audio message generated by text-to-speech processing) to the Mobile User in its target area.

In block 6057, the Mobile User in the target area of the Networked Digital Sign enters the conveyed PIN into the Cloud Service Application executing on the mobile unit of the Mobile User.

In block 6059, the Cloud Service Application executing on the mobile unit communicates the entered PIN to the Cloud Transaction Bridge 69 using networked communications (via messaging over the Radio Access Network, the Packet Switched Core Network 19 and the IP Access Network/Internet 17).

In block 6061, the Cloud Transaction Bridge 69 receives the PIN communicated from the mobile unit in block 6059 and matches it to the PIN communicated in block 6053 to identify correspondence between the mobile unit and the Networked Digital Sign, and the operations continue to block 6063.

In block 6063, the Cloud Transaction Bridge 69 uses the one-to-one correspondence between the mobile unit and the Networked Digital Sign to issue a Request for EPC message to the Transaction Servicing Logic 71 as described above with respect to FIG. 4B.

FIG. 7 illustrates exemplary functionality of a mobile unit (11A or 11B) in generating a Mobile-to-POS Meet-Me Request message as described above with respect to FIG. 4A. In block 7001, the Cloud Service Application executing on the mobile unit periodically samples the output of accelerometer(s) of the mobile unit over time.

In block 7003, the Cloud Service Application executing on the mobile unit processes the accelerometer output samples of block 7001 to detect whether the Mobile User has performed a gesture that conveys an intent to interact with a Networked POS Terminal. Such processing involves detecting gesture as a sequence of significant movements of the device that match predefined gesture patterns that indicate a consumer's intent to interact with the Networked POS Terminal.

In block 7005, the Cloud Service Application executing on the mobile unit determines whether the processing of block 7003 has detected the likely occurrence of a hand-based gesture by a Mobile User. If not, the operations return to block 7003. If so, the operations continue to block 7007.

In block 7007, the Cloud Service Application executing on the mobile unit generates a Mobile-to-POS Meet-Me Request message for communication to the Cloud Transaction Bridge 69 using networked communications (via messaging over the Radio Access Network 16, the Packet Switch Core Network 19 and the IP Access Network/Internet 17). The Mobile-to-POS Meet-Me Request message includes the Mobile User ID (stored in the mobile unit (FIG. 2B), geolocation data of the mobile unit output from a GPS or other geolocation services integral to the mobile unit, and possibly parameters characterizing the detected gesture from block 7003.

In block 7009, the Mobile-to-POS Meet-Me Request message generated in block 7007 is communicated from the mobile unit to the Cloud Transaction Bridge 69 using networked communications (via messaging over the Radio Access Network 16, the Packet Switch Core Network 19 and the IP Access Network/Internet 17).

FIG. 7B1 and 7B2 illustrate exemplary functionality of the Cloud Transaction Bridge 69 in processing Mobile-to-POS Meet-Me Request messages and POS-to-Mobile Meet Me Request messages to determine a logical connection or link (i.e., a one-to-one correspondence) between a Networked POS Terminal and a respective mobile unit.

In block 7011, the Cloud Transaction Bridge 69 receives the POS-to-Mobile Meet-Me Request. In block 7013, the Cloud Transaction Bridge 69 generates a time stamp for the POS-to-Mobile Meet-Me Request received in block 7011. In block 7015, the Cloud Transaction Bridge 69 adds the POS-to-Mobile Meet-Me-Request received in block 7011 together with its associated time stamp generated in block 7013 to a Queue of Active POS-to-Mobile Meet-Me-Requests (block 7017).

In block 7019, the Cloud Transaction Bridge 69 receives the Mobile-to-POS Meet-Me Request. In block 7021, the Cloud Transaction Bridge 69 generates a time stamp for the Mobile-to-POS Meet-Me Request received in block 7019. In block 7023, the Cloud Transaction Bridge 69 adds the Mobile-to-POS Meet-Me-Request received in block 7019 together with its associated time stamp generated in block 7021 to a Queue of Active Mobile-to-POS Meet-Me-Requests (block 7025).

The Mobile-to-POS and POS-to-Mobile Meet-Me Request message pair that corresponds to a given interaction between a Mobile User and a Networked POS Terminal are communicated to the Cloud Transaction Bridge 69 in an asynchronous manner. Moreover, in large scale deployments, there can be a number of Meet-Me Request message pairs corresponding to different interactions that are received at the Cloud Transaction Bridge 69 at or near the same time. In order to address these issues, in block 7027, the Cloud Transaction Bridge 69 processes the queue of Active Mobile-to-POS Meet-Me Requests to determine one-to-one correspondence to a respective active POS-to-Mobile Meet-Me Request. The processing of block 7027 involves a hierarchical three tier correlation scheme involving spatial and temporal correlation processing:
first-tier correlation—the geolocation data of the respective active Mobile-to-Sign Meet-Me request corresponds to the location of the store as derived from the Store ID of the respective active POS-to-Mobile Meet-Me Request;
second tier correlation—the time stamp of the respective active Mobile-to-POS Meet-Me request falls within a time window corresponding to the time stamp for the respective active POS-to-Mobile Meet-Me Request; and
third tier correlation—the goods or services to be purchased as encoded in the POS-to-Mobile Meet-me requests can be correlated to the items of EPC of the virtual wallet of the Mobile Users of the received Mobile-to-POS Meet-me requests.
   The correlations provide a confidence level. Multiple algorithms can be used to generate a number of confidence levels. Weighting factors can be used to combine the confidence levels. The resultant confidence level is compared against a threshold to indicate a correspondence. The satisfaction of the first and second tiers of correlation identify one-to-one correspondence between a respective active Mobile-to-POS Meet-Me Request and a respective active POS-to-Mobile Meet-Me Request in the event that there are no other possible queued Meet-Me Request pairs that share the respective active Mobile-to-POS Meet-Me Request or the respective active POS-to-Mobile Meet-Me-Request (i.e., there is no collision between a number of queued Meet-Me Request pairs). In the event there is such a collision, the third tier correlation can be used.

In block 7029, the Cloud Transaction Bridge 69 determines whether there is correlation success for a given active Mobile-to-POS Meet-Me Request in the processing of block 7027. If so, the operations continue to block 7043. In the event that the correlation fails for a given active Mobile-to-POS Meet-Me Request (block 7031), the operations continue to blocks 7033 to 7041 to carry out a PIN exchange method that provides a logical connection or link (i.e., a one-to-one correspondence) between a Networked POS Terminal and a respective mobile unit.

In block 7033, the Cloud Transaction Bridge generates a PIN, stores the PIN and communicates the PIN to the mobile unit that communicated the given active Mobile-to-POS Meet-Me request using networked communications (via messaging over the Radio Access Network, the Packet Switched Core Network 19 and the IP Access Network/Internet 17).

In block 7035, the Cloud Service Application executing on the mobile unit receives the PIN and displays the PIN to the Mobile User. The Mobile User conveys the PIN (for example by verbal communication) to the checkout clerk of the Networked POS Terminal (or possibly conveys the PIN by entering it into the Networked POS Terminal.

In block 7037, the conveyed PIN is entered into the Networked POS Terminal (if not done so in block 7035).

In block 7039, the Networked POS Terminal communicates the entered PIN to the Cloud Transaction Bridge 69 using networked communications (via messaging over the IP Access Network/Internet 17).

In block 7041, the Cloud Transaction Bridge 69 receives the PIN communicated from the Networked POS Terminal in block 7041 and matches it to the PIN communicated in block 7033 to identify correspondence between the mobile unit and the Networked POS Terminal, and the operations continue to block 7043.

In block 7043, the Cloud Transaction Bridge 69 uses the one-to-one correspondence between the mobile unit and the Networked POS Terminal to process checkout data and data for user-selected EPC items as described above with respect to FIG. 5B.

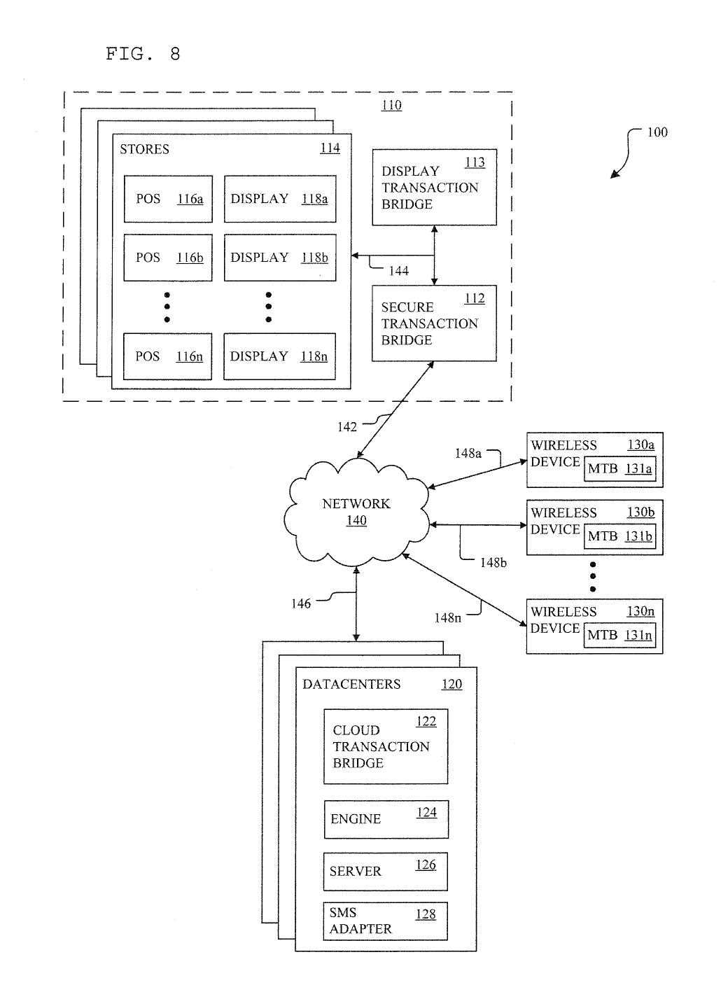

FIG. 8 illustrates an exemplary embodiment of an offer redemption system 100, which includes one or more retailers 110, one or more datacenters 120, one or more wireless devices 130a-n, a network 140, and communication links 142, 144, 146 and 148a-n. One or more retailers 110 comprises a secure transaction bridge 112, a display transaction bridge 113 and one or more stores 114. Each of these one or more stores 114 comprises one or more point of sale (POS) terminals 116a-n and one or more digital display signs 118a-n. One or more datacenters 120 comprises a cloud transaction bridge 122, a promotion and redemption engine 124, a mobile application server 126 and a short message service (SMS) adapter 128. In addition, or as an alternative, cloud transaction bridge 122 comprises a secure transaction bridge 112. Each of the one or more wireless devices 130a-n comprises a mobile transaction bridge (MTB) 131a-n.

In one embodiment, one or more retailers 110 including secure transaction bridge 112, display transaction bridge 113, one or more stores 114, one or more POS terminals 116a-n, and one or more digital display signs 118a-n are coupled with network 140 using communications links 142 and 144, which may be any wireline, wireless, or other link suitable to support data communications between one or more retailers 110 and network 140. One or more datacenters 120 is coupled with network 140 using communications link 146, which may be any wireline, wireless, or other link suitable to support data communications between one or more datacenters 120 and network 140. One or more wireless devices 130a-n is coupled with network 140 using communications links 148a-n, which may be any wireless or other link suitable to support data communications between one or more wireless devices 130a-n and network 140.

Although communication links 142, 144, 146 and 148a-n are shown as generally coupling one or more retailers 110, one or more datacenters 120, and one or more wireless devices 130a-n to network 140, one or more retailers 110, one or more datacenters 120, and one or more wireless devices 130a-n may communicate directly with one or more retailers 110, one or more datacenters 120, and one or more wireless devices 130a-n, according to particular needs.

In another embodiment, network 140 includes the Internet and any appropriate local area network (LAN), metropolitan area network (MAN), or wide area networks (WAN) coupling one or more retailers 110, one or more datacenters 120, and one or more wireless devices 130a-n. For example, data may be maintained by one or more retailers 110 at one or more locations external to one or more retailers 110 and one or more datacenters 120 and made available to one or more associated users of one or more datacenters 120 using network 140 or in any other appropriate manner. Those skilled in the art will recognize that the complete structure and operation of communication network 140 and other components within offer redemption system 100 are not depicted or described. Embodiments may be employed in conjunction with known communications networks and other components.

In addition, although one or more retailers 110 is shown and described as comprising a particular configuration of secure transaction bridge 112, display transaction bridge 113, stores 114, POS terminals 116a-n, and digital display signs 118a-n, embodiments contemplate any suitable configuration of secure transaction bridge 112, display transaction bridge 113, stores 114, POS terminals 116a-n, and digital display signs 118a-n. For example, the deployment of secure transaction bridge 112 and/or display transaction bridge 113 may be configured as a centralized deployment, such that, secure transaction bridge 112 and/or display transaction bridge 113 are integrated on a store, regional or corporate back end system of one or more retailers 110. Multiple POS terminals 116a-n communicate with a centralized secure transaction bridge 112 and/or display transaction bridge 113 that in turn communicates with the one or more datacenters 120. In addition, or as an alternative, the deployment of secure transaction bridge 112 and/or display transaction bridge 113 may be configured as a unit deployment, such that, secure transaction bridge 112 and/or display transaction bridge 113 are integrated on each POS terminal 116a-n and each POS terminal 116a-n communicates with the one or more datacenters 120.

In one embodiment, multiple digital display signs 118a-n also communicate with a centralized display transaction bridge 113 and/or display transaction bridge 113 that in turn communicates with the one or more datacenters 120. In addition, the deployment of secure transaction bridge 112 and/or display transaction bridge 113 may also be configured as a hybrid deployment, such that, the functionality of secure transaction bridge 112 and/or display transaction bridge 113 are split between individual POS terminals 116a-n and a central back end system of one or more retailers 110. The backend system of one or more retailers 110 communicates with the one or more datacenters 120. As used herein, the one or more retailers 110 may be any retailer, seller, individual, business, or entity that conducts a transaction or provides electronic content with one or more users associated with one or more wireless devices 130a-n.

Moreover, one or more retailers 110 may operate on one or more computers comprising one or more databases or other data storage arrangements at one or more locations which are integral to or separate from the hardware and/or software that supports secure transaction bridge 112, display transaction bridge 113, one or more stores 114 and one or more point of sale (POS) terminals 116a-n.

Likewise, one or more datacenters 120 may operate on one or more computers comprising one or more databases or other data storage arrangements at one or more locations which are integral to or separate from the hardware and/or software that supports cloud transaction bridge 122, promotions and redemption engine 124, mobile application server 126 and a short message service (SMS) adapter 128. The computers may include any suitable input device, such as a keypad, mouse, touch screen, microphone, or other device to input information. An output device may convey information associated with the operation of offer redemptions, including digital or analog data, visual information, or audio information. The computers may include fixed or removable non-transitory computer-readable storage media, such as magnetic computer disks, CD-ROM, or other suitable computer-readable storage media to receive output from and provide input to one or more retailers 110. The computers may include one or more processors and associated memory to execute instructions and manipulate information according to the operation of offer redemption system 100.

In one embodiment, secure transaction bridge 112 provides an interface between one or more POS terminals 116a-n and one or more datacenters 120 to enable the one or more retailers 110 to participate in electronic offer promotion redemption. Among other things, secure transaction bridge 112 registers and authenticates one or more POS terminals 116a-n with one or more datacenters 120, enables a “MeetMe” authentication process between one or more wireless devices 130a-n and a specific POS terminal 116a-n, enables the exchange of offers, such as, for example, coupons from one or more datacenters 120 and one or more POS terminals 116a-n and generates and communicates final transaction to cloud transaction bridge 122 for receipt and/or summary messaging to users and for audit/logging purposes of one or more datacenters 120.

In another embodiment, display transaction bridge 113 provides an interface between one or more digital display signs 118a-n and one or more datacenters 120 to enable the one or more retailers 110 to participate in electronic content exchange. Among other things, display transaction bridge 113 registers and authenticates one or more digital display signs 118a-n with one or more datacenters 120, enables a “MeetMe” authentication process between one or more wireless devices 130a-n and a specific digital display signs 118a-n and enables the exchange of electronic content, such as, for example, coupons, offers, promotions, URL's, videos, or any other electronic content from one or more datacenters 120 and one or more digital display signs 118a-n.

Cloud Transaction Bridge 122 provides communications between one or more POS terminals 116a-n and one or more wireless devices 130a-n which facilitates secure digital offer redemption and electronic content exchange between users using one or more wireless devices 130a-n and one or more retailers 110, Among other things, this allows for the registration of one or more wireless devices 130a-n and one or more POS terminals 116a-n with one or more datacenters 120, validates the authenticity of the users of the one or more wireless devices 130a-n and one or more POS terminals 116a-n, supports the look-up of offers and retailer locations for user consumption, and enables the exchange of offers and final transaction processing with the one or more POS terminals 116a-n.

Additionally, in an embodiment, Cloud Transaction Bridge 122 provides communications between one or more digital display signs 118a-n and one or more wireless devices 130a-n which facilitates secure digital offer redemption and electronic content exchange between users using one or more wireless devices 130a-n and one or more retailers 110, Among other things, this allows for the registration of one or more wireless devices 130a-n and one or more digital display signs 118a-n with one or more datacenters 120, validates the authenticity of the users of the one or more wireless devices 130a-n and digital display signs 118a-n, supports the look-up of offers and retailer locations for user consumption, and enables the exchange of electronic offers and content with the one or more digital display signs 118a-n.

Promotions and redemption engine 124 provides for processing and searching electronic offers and content, managing an offer or coupon wallet (i.e., an eWallat), and managing user subscriptions. In one embodiment, one or more datacenters 120 and in particular cloud transaction bridge 122 provides for targeting individualized offers and/or content to one or more wireless devices 130a-n based on demographics, psychographics, predictive analytics, and/or broad based delivery of offers that are targeted for a larger audience. In addition, these offers are stored within an offer or coupon wallet at one or more datacenters 120 and may be stored, at least temporarily, on one or more wireless devices 130a-n. Short message service (SMS) adapter 128 provides communication with short message service (SMS) wireless devices 130a-n to enable interaction with offer redemption system 100 and allows these one or more wireless devices 130a-n to search, select, and redeem electronic offers and/or content easily via short message service (SMS) workflows.

One or more wireless devices 130a-n comprises a processor, memory and data storage. The processor executes an operating system program stored in memory to control the overall operation of one or more wireless devices 130a-n. For example, the processor controls the reception of signals and the transmission of signals within offer redemption system 100. The processor executes other processes and programs resident in memory, such as, for example, mobile transaction bridge (MTB) 131a-n and moves data into or out of the memory, as required by an executing process.

Mobile transaction bridge (MTB) 131a-n allows applications across multiple phone platforms to communicate with Cloud Transaction Bridge 130a-n and thus participate in electronic offer and content exchange. Among other things, mobile transaction bridge 131a-n registers users of one or more wireless devices 130a-n with one or more datacenters 120, provides secure communications between one or more wireless devices 130a-n and cloud transaction bridge 122, allows for the searching of electronic offers and content and looking up one or more stores 114 locations and services, and enables the “MeetMe” authentication process which connects a specific wireless devices 130a-n with a specific POS terminals 116a-n via cloud transaction bridge 122, to complete a transaction or purchase.

Those skilled in the art will recognize that one or more wireless devices 130a-n are given by way of example and that for simplicity and clarity, only so much of the construction and operation of one or more wireless devices 130a-n as is necessary for an understanding of the present invention is shown and described. Moreover, it is understood that one or more wireless devices 130a-n should not be construed to limit the types of devices in which embodiments of the present invention may be implemented. For example, one or more wireless devices 130a-n may be any wireless device, including, but not limited to, conventional cellular or mobile telephones, smart mobile phones, paging devices, personal digital assistant devices, short message service (SMS) wireless devices, portable computers, or any other device capable of wireless or network communication.

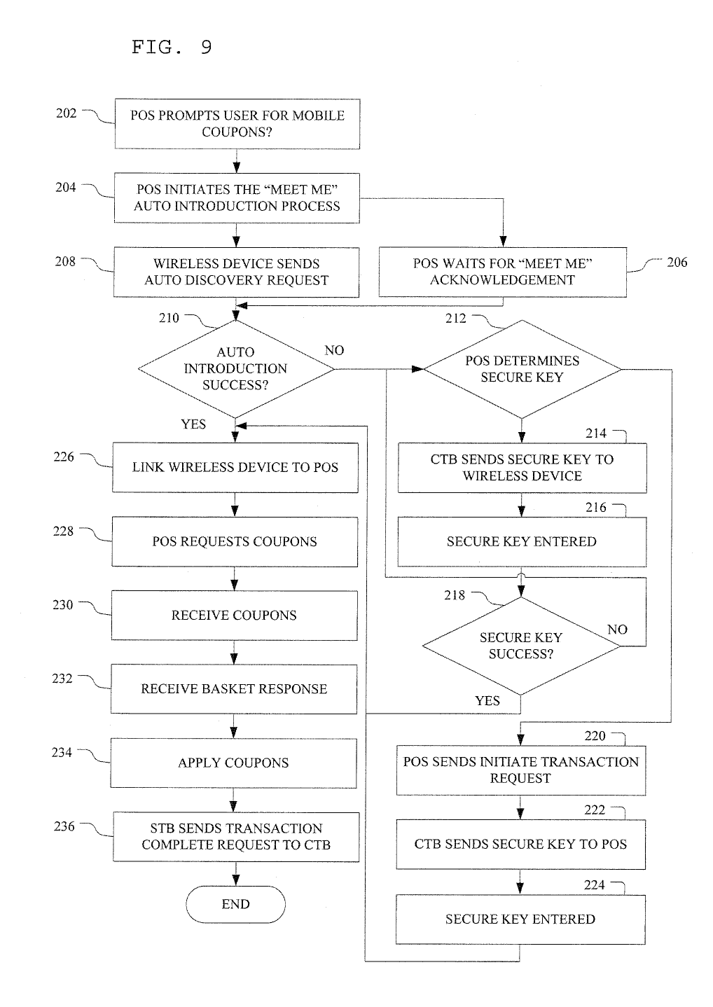

FIG. 9 illustrates an exemplary method 200 of electronic offer promotion redemption. The method begins at step 202, where a user selects items for purchase at one or more stores 114 and approaches a point of sale (POS) terminal 116a-n. The point of sale (POS) terminal 116a-n begins to “ring up” the items and at any point during the transaction, prompts the user (i.e., cashier asks the user or the point of sale (POS) terminal 116a-n prompts the user on a display) for electronic offers, i.e., mobile offers, mobile coupons. The user indicates, for example, that they have mobile offers.

At step 204, the point of sale (POS) terminal 116a-n initiates a “MeetMe” automatic introduction process which allows the point of sale (POS) terminal 116a-n and the user's wireless device 130a-n to be connected via cloud transaction bridge 122. In one embodiment, the one of more point of sale terminals (POS) 116a-n comprises a “mobile offers/coupons” function that allows a cashier or a point of sale terminal (POS) 116a-n to initiate a “MeetMe” request to enable the exchange of mobile offers.

Continuing with step 204, the point of sale (POS) terminal 116a-n generates and sends an “instantiate transaction” request to cloud transaction bridge 122 via secure transaction bridge 112 to initiate the “MeetMe” automatic introduction process. In addition, the point of sale (POS) terminal 116a-n generates and sends “basket” data (i.e., items in the current transaction) to cloud transaction bridge 122 via secure transaction bridge 112.

At step 206, the point of sale (POS) terminal 116a-n waits for the user to complete the “MeetMe” automatic introduction process via the user's wireless device 130a-n. In one embodiment, a status message is displayed on the point of sale (POS) terminal 116a-n while the “MeetMe” automatic introduction process is running in the background.

At step 208, the wireless device 130a-n generates and sends an automatic introduction request to cloud transaction bridge 122. As discussed above, the “MeetMe” automatic introduction process connects the point of sale (POS) terminal 116a-n and the wireless device 130a-n via cloud transaction bridge 122 to enable the exchange of mobile offers. In one embodiment, the user using, for example, a smart phone “shakes” the wireless device 130a-n to initiate the “MeetMe” automatic introduction process. In another embodiment, the user presses a button or otherwise activates the wireless device 130a-n to initiate the “MeetMe” automatic introduction process. Although a smart phone is discussed as an exemplary wireless device to initiate the “MeetMe” automatic introduction process of the wireless device 130a-n by “shaking,” embodiments contemplate “flicking” or “moving” any wireless device having an accelerometer or having any other like device.

At step 210, cloud transaction bridge 122 determines whether the “MeetMe” automatic introduction process between the point of sale (POS) terminal 116a-n and the wireless devices 130a-n was successful. If so, the method proceeds to step 226, otherwise the method proceeds to step 212. In one embodiment, cloud transaction bridge 122 determines a confidence level associated with the “MeetMe” automatic introduction process between the point of sale (POS) terminal 116a-n and the wireless devices 130a-n to determine whether the “MeetMe” automatic introduction process was successful. If the confidence level is above a predetermined threshold, the method proceeds to step 226, otherwise the method proceeds to step 212.

In an embodiment, cloud transaction bridge 122 determines a confidence level associated with the “MeetMe” automatic introduction process. In one embodiment, the confidence level of the “MeetMe” automatic introduction process is determined by calculating the confidence of a “good” meeting between a wireless devices 130a-n and a point of sale (POS) terminal 116a-n. As an example only, and not by way of limitation, the confidence level is determined by using real time localized data, long term statistical trends and environmental data to calculate a collection of confidence ratings for the “MeetMe” automatic introduction process being attempted. In an embodiment, the individual confidence ratings are combined to produce an overall confidence of the “MeetMe” automatic introduction process, wherein the overall confidence value may be compared with a desired confidence threshold and the “MeetMe” automatic introduction process is accepted or rejected. In another embodiment, a desired confidence level may be different for each retailer 110, store 114, and point of sale (POS) terminal 116a-n.

At step 212, the point of sale (POS) terminal 116a-n determines whether to initiate a user secure key introduction process or a retailer secure key introduction process, since the “MeetMe” automatic introduction process failed. If the point of sale (POS) terminal 116a-n initiates a user secure key introduction process, the method proceeds to step 214, otherwise the method proceeds to step 220. At step 214, cloud transaction bridge 122 generates and communicates a unique transaction secure key (i.e., a reference code, a personal identification number code or any other code) to the wireless devices 130a-n.

At step 216, the point of sale (POS) terminal 116a-n presents a dialogue box or otherwise prompts a cashier or the user of the wireless devices 130a-n to enter the received secure key into the point of sale (POS) terminal 116a-n or other personal identification number device. At step 218, cloud transaction bridge 122 generates and communicates a response to the point of sale (POS) terminal 116a-n as to whether the secure key introduction process was successful. In one embodiment, if the secure key introduction process fails then an error message is displayed on the point of sale (POS) terminal 116a-n and the secure key may be reentered or the method returns to step 212.

At step 220, the point of sale (POS) terminal 116a-n sends an “initiate transaction” request to the cloud transaction bridge 122. At step 222, cloud transaction bridge 122 generates and communicates a unique transaction secure key (i.e., a reference code, a personal identification number code or any other code) to the point of sale (POS) terminal 116a-n. At step 224, the wireless devices 130a-n presents a dialogue box or otherwise prompts the user of the wireless devices 130a-n to enter the received secure key into the wireless devices 130a-n. The cloud transaction bridge 122 generates and communicates a response to the point of sale (POS) terminal 116a-n as to whether the secure key introduction process was successful. In one embodiment, if the secure key introduction process fails then an error message is displayed on the point of sale (POS) terminal 116a-n or the wireless devices 130a-n and the secure key may be reentered.

At step 226, cloud transaction bridge 122 generates and communicates a response to the point of sale (POS) terminal 116a-n and the wireless devices 130a-n which connects or links the point of sale (POS) terminal 116a-n via secure transaction bridge 112 with the wireless devices 130a-n to enable the exchange of offers. At step 228, the point of sale (POS) terminal 116a-n generates and sends a request for offers to cloud transaction bridge 122, that are applicable at that particular store 114, for that particular user associated with the wireless devices 130a-n. In one embodiment, secure transaction bridge 112 generates a “retrieve offer” request and communicates the request to cloud transaction bridge 122. In another embodiment, secure transaction bridge 112 generates a “basket” request and communicates the request to cloud transaction bridge 122. In other embodiments, secure transaction bridge 112 generates both a “retrieve offer” request and a “basket” request and communicates the requests to cloud transaction bridge 122.

At step 230, point of sale (POS) terminal 116a-n receives offers via secure transaction bridge 112 that are applicable at that particular store 114, for that particular user associated with the wireless devices 130a-n, in response to the “retrieve offer” request from cloud transaction bridge 122. At step 232, the point of sale (POS) terminal 116a-n receives cloud based offers and/or one or more pre-calculated discounts (calculated at one or more datacenters 120) via secure transaction bridge 112, identified by the cloud transaction bridge 122, in response to the “basket” request.

At step 234, the point of sale (POS) terminal 116a-n finalizes the transaction and applies the offers or cloud based offers to the current transaction. The point of sale (POS) terminal 116a-n analyzes the items in the current transaction and “consumes” the offers for which the corresponding item is purchased and communicates the data to one or more datacenters 120. If, as discussed above, the offers are being redeemed in the cloud (cloud based offers) then the point of sale (POS) terminal 116a-n accepts the results of the cloud transaction and applies the appropriate discounts. In addition, secure transaction bridge 112 uses the offer information in the “basket” response to print any relevant offer information on a receipt. In addition, or as an alternative, a confirmation screen is displayed on the point of sale (POS) terminal 116a-n showing, for example, the number of offers applied and the total amount saved by using mobile offers.

At step 236, secure transaction bridge 112 generates and communicates final results of the transaction to cloud transaction bridge 122, which are communicated to the user of the wireless devices 130a-n and for storage in one or more datacenters 120. In addition, secure transaction bridge 112 informs the cloud transaction bridge 122 that the transaction is complete by sending a “transaction complete” request and the method ends. Although, FIG. 9 illustrates one embodiment of a method of electronic offer promotion redemption, various changes may be made to method 200 without departing from the scope of embodiments of the present invention.

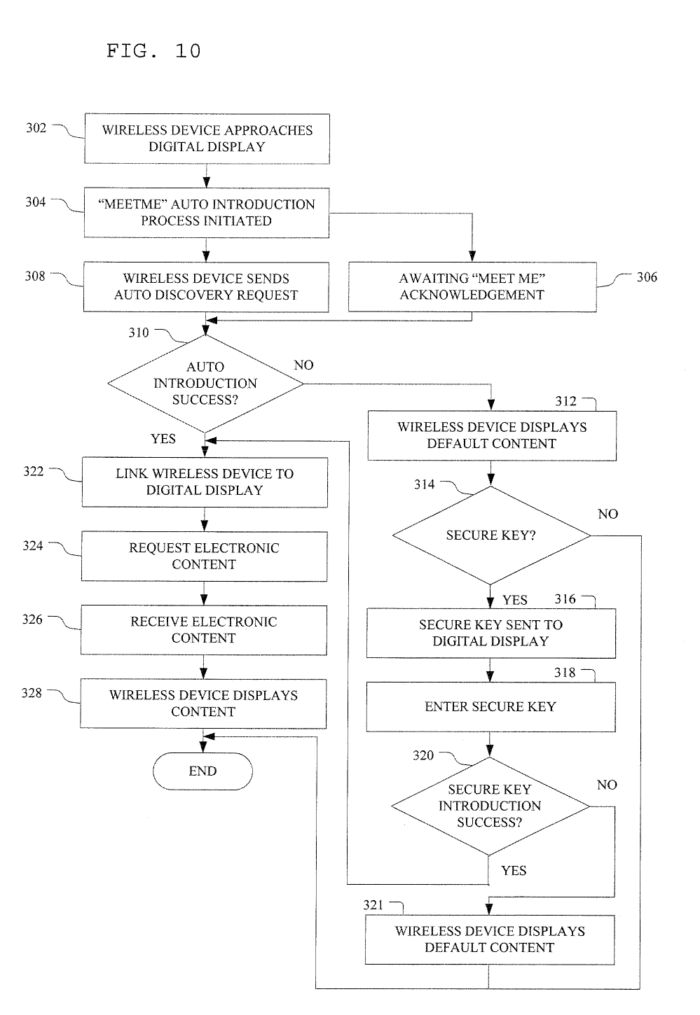

FIG. 10 illustrates an exemplary method 300 of electronic content exchange via a digital display sign 118a-n. In one embodiment, FIG. 10 provides additional method steps that may be employed prior to a user approaching the point of sale (POS) terminal 116a-n and initiating mobile coupon redemption as discussed in FIG. 9. In other embodiments, FIG. 10 enables the exchange of electronic content between wireless devices 130a-n and digital display signs 118a-n. The method begins at step 302, where a user approaches a digital display sign 118a-n. At step 304, a “MeetMe” automatic introduction process is initiated by either a wireless device 130a-n or a digital display sign 118a-n and allows the wireless device 130a-n and the digital display sign 118a-n to be connected via cloud transaction bridge 122 to enable the exchange of electronic content. As discussed above, electronic content may be any content, such as, for example, coupons, offers, promotions, URL's, videos, or any other electronic content.

At step 306, the digital display sign 118a-n waits for a user to complete the “MeetMe” automatic introduction process via the user's wireless device 130a-n. In one embodiment, a status message is displayed on the digital display sign 118a-n while the “MeetMe” automatic introduction process is running in the background. In one embodiment, one or more digital display signs 118a-n comprises a camera, gesture detection system, sensor or other device to detect a user's intent to interact with the digital display sign 118a-n.

At step 308, a user of a wireless device 130a-n using, for example, a smart phone “shakes” the wireless device 130a-n to initiate the “MeetMe” automatic introduction process. When the wireless device 130a-n detects a valid “shake,” the wireless device 130a-n sends an auto discovery request 308 via the cloud transaction bridge 122 to request one or more electronic offers or content while digital display sign 118a-n simultaneously connects via cloud transaction bridge 122. As discussed above, although a smart phone is discussed as an exemplary wireless device to initiate the “MeetMe” automatic introduction process of the wireless device 130a-n by “shaking,” embodiments contemplate “flicking,” “waving,” or otherwise “moving” any wireless device having an accelerometer or having any other like device. In another embodiment, the user presses a button or otherwise activates the wireless device 130a-n to initiate the “MeetMe” automatic introduction process. In other embodiments, digital display sign 118a-n detects a user's interaction, such as for example, any gesture, voice interaction or other intent to interact, to initiate the “MeetMe” automatic introduction process.

At step 310, cloud transaction bridge 122 determines whether the “MeetMe” automatic introduction process between the digital display sign 118a-n and the wireless device 130a-n was successful. If so, the method proceeds to step 322, otherwise the method proceeds to step 312. In one embodiment, cloud transaction bridge 122 determines a confidence level associated with the “MeetMe” automatic introduction process between the digital display sign 118a-n and the wireless device 130a-n to determine whether the “MeetMe” automatic introduction process was successful. If the confidence level is above a predetermined threshold, the method proceeds to step 322, otherwise the method proceeds to step 312. At step 312, wireless device 130a-n displays default content generated at the cloud transaction bridge 122.

In an embodiment, the digital display sign 118a-n must be previously registered with the offer redemption system 100 and have requested and received the appropriate configuration to allow the digital display sign 118a-n to utilize the “MeetMe” automatic introduction process. In this embodiment, cloud transaction bridge 122 determines whether prior registration and configuration of the digital display sign 118a-n has occurred and whether the geolocation of the user's wireless device 130a-n is within a predetermined proximity to the previously registered store 114 geolocation where digital display sign 118a-n is located. If the geolocaton of the user's wireless device 130a-n is not within the predetermined proximity to the digital display sign 118a-n, cloud transaction bridge 122 sends a message to the user's wireless device 130a-n prompting the user to choose a location. In one embodiment, cloud transaction bridge 122 sends a failure response to digital display sign 118a-n.

However, if the geolocation of the user's wireless device 130a-n is confirmed as being within the predetermined location proximity, cloud transaction bridge 122 determines a confidence level associated with the “MeetMe” automatic introduction process. In one such embodiment, the confidence level of the “MeetMe” automatic introduction process is determined by calculating the confidence of a “good” meeting between a wireless devices 130a-n and a digital display sign 118a-n. As an example only, and not by way of limitation, the confidence level is determined by using real time localized data, long term statistical trends and environmental data to calculate a collection of confidence ratings for the “MeetMe” automatic introduction process being attempted. In one embodiment, digital display sign 118a-n determines a “shake” or “wave” signature of a particular user associated with a wireless device 130a-n which is then applied as a factor in determining the confidence of the “MeetMe” automatic introduction process. In another embodiment, the individual confidence ratings are combined to produce an overall confidence of the “MeetMe” automatic introduction process, wherein the overall confidence value may be compared with a desired confidence threshold and the “MeetMe” automatic introduction process is accepted or rejected. In other embodiments, a desired confidence level may be different for each retailer 110, store 114, and digital display sign 118a-n.

At step 314, cloud transaction bridge 122 determines whether to initiate a secure key introduction process, since the “MeetMe” automatic introduction process failed. If a secure key introduction process is initiated, the method proceeds to step 316, otherwise the method ends. At step 316, cloud transaction bridge 122 generates and communicates a unique content secure key (i.e., a reference code, a personal identification number code or any other code) to the digital display sign 118a-n. At step 318, the digital display sign 118a-n displays the secure key and prompts the user of the wireless devices 130a-n to enter the secure key into the wireless devices 130a-n. At step 320, cloud transaction bridge 122 determines whether the “MeetMe” secure key introduction process between the digital display sign 118a-n and the wireless device 130a-n was successful. If so, the method proceeds to step 322, otherwise the method proceeds to step 321. At step 321, wireless device 130a-n displays default content generated at the cloud transaction bridge 122 and the method ends.

At step 322, cloud transaction bridge 122 generates and communicates a response to the digital display sign 118a-n and the wireless device 130a-n which connects or links the digital display sign 118a-n via display transaction bridge 113 with the wireless devices 130a-n to enable the exchange of electronic content. At step 324, the digital display sign 118a-n generates and sends a request for electronic offers or content cloud transaction bridge 122, that are applicable for that particular user or for electronic offers or content that is applicable for any user associated with one or more wireless device 130a-n to the appropriate component within datacenter 120 that stores such data.

At step 326, the wireless device 130a-n receives the electronic offers or content from the cloud transaction bridge 122 and at step 328, the wireless device 130a-n displays the electronic offers or content to the user. In one embodiment, the user then shops in the store 114 and selects items that match those defined by the electronic offers or content displayed on the user's wireless device 130a-n. At checkout, the user then approaches the point of sale (POS) terminal 116a-n and initiates an embodiment of the method of FIG. 9. In other embodiments, the user uses the received electronic offers or content outside of the one or more retailers 110 and the method ends. Although, FIG. 10 illustrates one embodiment of a method of electronic content exchange via a digital display sign 118a-n, various changes may be made to method 300 without departing from the scope of embodiments of the present invention.

Reference in the foregoing specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Advantageously, the systems and methods of the present application provide for management of the networked distribution of EPC together with the ability to measure the effectiveness of the EPC to specific consumers as well as the efficacy of such distribution.

Moreover, the systems and methods of the present invention allow for distribution of EPC to be tied seamlessly to the display of information, such as an Ad, on a Networked Digital Sign, and to tie the redemption of EPC to the displayed information.

Moreover, the systems and methods of the present invention allow real-time measurement of Promotional Campaigns in order to provide a true understanding of the effectiveness of such multiple forms of such Promotional Campaigns.

There have been described and illustrated herein several embodiments of a system and method for creating and managing campaigns of electronic promotional content, including networked distribution and redemption of such content. While particular embodiments of the invention have been described, it is not intended that the invention be limited thereto, as it is intended that the invention be as broad in scope as the art will allow and that the specification be read likewise. For example, the Cloud Service system can be scaled to interface to a large number of Mobile Users, a large number of retail stores (with a large number of Network Digital Signs and Networked POS Terminals). It is also contemplated that the Networked Digital Signs can be located in public places (not in a particular retail store as depicted in FIG. 1). In other examples, for large scale applications, the functionality of the Cloud Service can be distributed over multiple processing systems and load balancing systems can be used to distribute the processing loads over the distributed system. In yet another example, the functionality of the CMS service can be integrated into the Cloud Service as described herein. It will therefore be appreciated by those skilled in the art that yet other modifications could be made to the provided invention without deviating from its spirit and scope as claimed.

What is claimed is:

1. A system for use with a plurality of mobile units operated by Mobile Users as well as a plurality of Networked POS Terminals, the system comprising:
a database of items of electronic promotional content (EPC);
at least one transaction bridge operably coupled to the database and interfacing to the plurality of mobile units and to the plurality of Networked POS Terminals using network communication;
wherein said at least one transaction bridge is adapted to interface to the plurality of mobile units using network communication to provide for distribution of items of EPC to virtual wallets for said Mobile Users stored in said database and for storage of data in said database that reflects such distribution; and
wherein said at least one transaction bridge is adapted to interface to a particular Networked POS Terminal and to a particular mobile unit that are logically connected to one another for a respective point-of-sale transaction, wherein such interface allows said at least one transaction bridge or the particular Networked POS Terminal to generate first data that identifies zero or more items of EPC that are part of the virtual wallet of the Mobile User of the particular mobile unit and that match goods or services to be purchased as part of the respective point-of-sale transaction, said first data for use in redeeming such zero or more items of EPC as part of the respective point-of-sale transaction;
wherein said database is updated to store data that reflects redemption of items of EPC as identified by said first data.

2. A system according to claim 1, wherein:
said at least one transaction bridge is adapted to interface to a respective mobile unit using network communication to provide for distribution of at least one item of EPC to a virtual wallet for the Mobile User of the respective mobile unit and for storage of data in said database that reflects such distribution.

3. A system according to claim 1, wherein:
said at least one transaction bridge is adapted to receive asynchronous Meet-Me Request messages from both mobile units and from Networked POS Terminals and to match respective pairs of the received Meet-Me Request messages based upon spatial and temporal correlation processing of the received Meet-Me Request messages, wherein a given matched pair of Meet-Me Request messages is used to determine the logical connection between the particular Networked POS Terminal and the particular mobile unit.

4. A system according to claim 3, wherein:
the Meet-Me request message communicated from a respective mobile unit is triggered by automatic detection of a likely occurrence of a hand gesture by the mobile unit.

5. A system according to claim 4, wherein:
each mobile unit of the plurality of mobile units include software logic for automatic detection of the likely occurrence of a hand gesture.

6. A system according to claim 5, wherein:
the software logic processes the output of at least one accelerometer integral to the mobile unit in order to automatically detect the likely occurrence of a hand gesture.

7. A system according to claim 1, wherein:
contactless communication between the particular Networked POS Terminal and the particular mobile unit is used to determine the logical connection between the particular Networked POS Terminal and the particular mobile unit.

8. A system according to claim 1, wherein:
said at least one transaction bridge further interfaces to a plurality of Networked Digital Signs using network communications to provide for distribution of items of EPC to the virtual wallets for the Mobile Users stored in said database based on user interaction with the plurality of Networked Digital Signs and for storage of data in said database that reflects such distribution.

9. A system according to claim 8, wherein:
said at least one transaction bridge is adapted to interface to a particular mobile unit using network communication to provide for distribution of zero or more items of EPC to the virtual wallet for the Mobile User of the particular mobile unit stored in said database based on the Mobile User of the particular mobile unit interacting with a particular Networked Digital Sign that is logically connected thereto and for storage of data in said database that reflects such distribution.

10. A system according to claim 9, wherein:
said at least one transaction bridge is adapted to receive asynchronous Meet-Me Request messages from both mobile units and from Networked Digital Signs and to match respective pairs of the received Meet-Me Request messages based upon spatial and temporal correlation processing of the received Meet-Me Request messages, wherein a given matched pair of Meet-Me Request messages is used to determine the logical connection between the particular Networked Digital Sign and the particular mobile unit.

11. A system according to claim 10, wherein:
the Meet-Me request message communicated from a respective mobile unit is triggered by automatic detection of a likely occurrence of a hand gesture by the mobile unit.

12. A system according to claim 11, wherein:
each mobile unit of the plurality of mobile units include software logic for automatic detection of the likely occurrence of a hand gesture.

13. A system according to claim 12, wherein:
the software logic processes the output of at least one accelerometer integral to the mobile unit in order to automatically detect the likely occurrence of a hand gesture.

14. A system according to claim 10, wherein:
the Meet-Me request message communicated from a respective Networked Digital Sign is triggered by automatic detection of a likely occurrence of a hand gesture by the Networked Digital Sign.

15. A system according to claim 14, wherein:
each Networked Digital Sign includes an image-based system for automatic detection of the likely occurrence of a hand gesture.

16. A system according to claim 15, wherein:
each Networked Digital Sign further includes an image-based system for automatic detection of gender and approximate age of the Mobile User.

17. A system according to claim 9, wherein:
contactless communication between the particular Networked Digital Sign and the particular mobile unit is used to determine the logical connection between the particular Networked Digital Sign and the particular mobile unit.

18. A system according to claim 9, wherein:
said at least one transaction bridge is adapted to receive content data identifying specific media content displayed on the particular Networked Digital Sign at the time corresponding to the Mobile User of the particular mobile unit interacting with the particular Networked Digital Sign; and
the system further includes first logic that uses the content data to search the database to identify zero or more items of EPC that are related to the specific media content and to forward the zero or more items of EPC to said at least one transaction bridge for addition to the virtual wallet of the Mobile User of the particular mobile unit stored in said database.

19. A system according to claim 18, wherein:
the specific media contact is an Ad for particular goods or services and said first logic uses the content data to search the database to identify zero or more items of EPC that are directly related to the particular goods or services.

20. A system according to claim 18, wherein:
said first logic uses the content data to search the database to identify zero or more items of EPC that are indirectly related to the specific media content for cross-selling purposes and for addition to the virtual wallet of the Mobile User of the particular mobile unit stored in said database.

21. A system according to claim 20, wherein:
said first logic receives gender and approximate age of the Mobile User as derived by an image-based system of the particular Networked Digital Sign and utilizes at least one of the received gender and approximate age of the Mobile User in searching said database to identify the zero or more items of EPC that are indirectly related to the specific media content.

22. A system according to claim 9, further comprising:
second logic that searches the database to identify zero or more items of EPC based upon a profile of the Mobile User and that adds such items of EPC to the virtual wallet of the Mobile User of the particular mobile unit stored in said database.

23. A system according to claim 22, wherein:
said second logic receives gender and approximate age of the Mobile User as derived by an image-based system of the particular Networked Digital Sign and utilizes at least one of the received gender and approximate age of the Mobile User as part of the profile of the Mobile User in searching said database to identify the zero or more items of EPC.

24. A system according to claim 1, further comprising:
third logic for interacting with Promoting Entity users using network communication to define Promotional Campaigns which specify the items of EPC stored in said database; and
a tracking module that processes the data stored in said database to generate real-time metrics for the Promotional Campaigns.

25. A system according to claim 24, wherein:
said third logic provides for interaction with a respective Promoting Entity user to report the real-time metrics for at least one Promotional Campaign associated with the respective Promoting Entity user and to manage the at least one Promotional Campaign based on such report.

26. A system according to claim 24, wherein:
said third logic provides for interaction with a respective Promoting Entity user to update in real time at least one Promotional Campaign associated with the respective Promoting Entity user.

27. A method for use with a plurality of mobile units operated by Mobile Users as well as a plurality of Networked POS Terminals, the method comprising:
storing information in a database, said information representing a plurality of items of electronic promotional content (EPC);
providing at least one transaction bridge operably coupled to the database;
distributing items of EPC to virtual wallets for the Mobile Users stored in said database and for storing data in said database that reflects such distribution;
using network communication to interface said at least one transaction to a particular Networked POS Terminal and to a particular mobile unit that are logically connected to one another for a respective point-of-sale transaction, wherein such network communication allows said at least one transaction bridge or the particular Networked POS Terminal to generate first data that identifies zero or more items of EPC that are part of the virtual wallet of the Mobile User of the particular mobile unit and that match goods or services to be purchased as part of the respective point-of-sale transaction, said first data for use in redeeming such zero or more items of EPC as part of the respective point-of-sale transaction; and
updating said database to store data that reflects redemption of items of EPC as identified by said first data.

28. A method according to claim 27, wherein:
said at least one transaction bridge interfaces to a respective mobile unit to provide for distribution of at least one item of EPC to a virtual wallet for the Mobile User of the respective mobile unit and for storage of data in said database that reflects such distribution.

29. A method according to claim 27, wherein:
said at least one transaction bridge receives asynchronous Meet-Me Request messages from both mobile units and from Networked POS Terminals and matches respective pairs of the received Meet-Me Request messages based upon spatial and temporal correlation processing of the received Meet-Me Request messages, wherein a given matched pair of Meet-Me Request messages is used to determine the logical connection between the particular Networked POS Terminal and the particular mobile unit.

30. A method according to claim 29, wherein:
the Meet-Me request message communicated from a respective mobile unit is triggered by automatic detection of a likely occurrence of a hand gesture by the mobile unit.

31. A method according to claim 30, wherein:
each mobile unit of the plurality of mobile units utilizes software logic to automatically detect the likely occurrence of a hand gesture.

32. A method according to claim 31, wherein:
the software logic processes the output of at least one accelerometer integral to the mobile unit in order to automatically detect the likely occurrence of a hand gesture.

33. A method according to claim 27, wherein:
contactless communication between the particular Networked POS Terminal and the particular mobile unit is used to determine the logical connection between the particular Networked POS Terminal and the particular mobile unit.

34. A method according to claim 27, further comprising:
using network communication to interface said at least one transaction bridge to a plurality of Networked Digital Signs to provide for distribution of items of EPC to the virtual wallets for the Mobile Users stored in said database based on user interaction with the plurality of Networked Digital Signs and for storage of data in said database that reflects such distribution.

35. A method according to claim 34, wherein:
said at least one transaction bridge interfaces to a particular mobile unit to provide for distribution of zero or more items of EPC to the virtual wallet for the Mobile User of the particular mobile unit stored in said database based on the Mobile User of the particular mobile unit interacting with a particular Networked Digital Sign that is logically connected thereto and for storage of data in said database that reflects such distribution.

36. A method according to claim 35, wherein:
said at least one transaction bridge receives asynchronous Meet-Me Request messages from both mobile units and from Networked Digital Signs and matches respective pairs of the received Meet-Me Request messages based upon spatial and temporal correlation processing of the received Meet-Me Request messages, wherein a given matched pair of Meet-Me Request messages is used to determine the logical connection between the particular Networked Digital Sign and the particular mobile unit.

37. A method according to claim 36, wherein:
the Meet-Me request message communicated from a respective mobile unit is triggered by automatic detection of a likely occurrence of a hand gesture by the mobile unit.

38. A method according to claim 37, wherein:
each mobile unit of the plurality of mobile units utilizes software logic to automatically detect the likely occurrence of a hand gesture.

39. A method according to claim 38, wherein:
the software logic processes the output of at least one accelerometer integral to the mobile unit in order to automatically detect the likely occurrence of a hand gesture.

40. A method according to claim 36, wherein:
the Meet-Me request message communicated from a respective Networked Digital Sign is triggered by automatic detection of a likely occurrence of a hand gesture by the respective Networked Digital Sign.

41. A method according to claim 40, wherein:
each Networked Digital Sign utilizes an image-based system to automatically detect the likely occurrence of a hand gesture.

42. A method according to claim 41, wherein:
each Networked Digital Sign further utilizes an image-based system to automatically detect gender and approximate age of the Mobile User.

43. A method according to claim 35, wherein:
contactless communication between the particular Networked Digital Sign and the particular mobile unit is used to determine the logical connection between the particular Networked Digital Sign and the particular mobile unit.

44. A method according to claim 35, wherein:
said at least one transaction bridge receives content data identifying specific media content displayed on the particular Networked Digital Sign at the time corresponding to the Mobile User of the particular mobile unit interacting with the particular Networked Digital Sign; and
the content data is used to search the database to identify zero or more items of EPC that are related to the specific media content and to forward the zero or more items of EPC to said at least one transaction bridge for addition to the virtual wallet of the Mobile User of the particular mobile unit stored in said database.

45. A method according to claim 44, wherein:
the specific media contact is an Ad for particular goods or services and said first logic uses the content data to search the database to identify zero or more items of EPC that are directly related to the particular goods or services.

46. A method according to claim 44, wherein:
the content data is used to search the database to identify zero or more items of EPC that are indirectly related to the specific media content for cross-selling purposes and to forward the zero or more items of EPC to said at least one transaction bridge for addition to the virtual wallet of the Mobile User of the particular mobile unit stored in said database.

47. A method according to claim 46, further comprising:
using an image-based system of the particular Networked Digital Sign to derive gender and approximate age of the Mobile User;
using network communication to communicate the gender and approximate age of the Mobile User from the particular Networked Digital Sign to said at least one transaction bridge;
receiving the gender and approximate age of the Mobile User at the transaction bridge;
using at least one of the received gender and approximate age of the Mobile User in searching said database to identify the zero or more items of EPC that are indirectly related to the specific media content.

48. A method according to claim 35, further comprising:
searching the database to identify zero or more items of EPC based upon a profile of the Mobile User and to forward the zero or more items of EPC to said at least one transaction bridge for addition to the virtual wallet of the Mobile User of the particular mobile unit stored in said database.

49. A method according to claim 38, further comprising:
using an image-based system of the particular Networked Digital Sign to derive gender and approximate age of the Mobile User;
using network communication to communicate the gender and approximate age of the Mobile User from the particular Networked Digital Sign to said at least one transaction bridge;
receiving the gender and approximate age of the Mobile User at the transaction bridge;
using at least one of the received gender and approximate age of the Mobile User as part of the profile of the Mobile User in searching said database to identify the zero or more items of EPC.

50. A method according to claim 27, further comprising:
interacting with Promoting Entity users using network communication to define Promotional Campaigns which specify the items of EPC stored in said database; and
processing the data stored in said database to generate real-time metrics for the Promotional Campaigns.

51. A method according to claim 50, further comprising:
Interacting with a respective Promoting Entity user using network communication to report the real-time metrics for at least one Promotional Campaign associated with the respective Promoting Entity user and to manage the at least one Promotional Campaign based on such report.

52. A method according to claim 50, wherein:
the interaction with the respective Promoting Entity user provides for real-time update of at least one Promotional Campaign associated with the respective Promoting Entity user.
